(19) United States
(12) Patent Application Publication
(10) Pub. No.: US 2023/0334411 A1
(43) Pub. Date: Oct. 19, 2023

(54) INFORMATION PROCESSING

(71) Applicant: Rajax Network Technology (Shanghai) Co., Ltd., Shanghai (CN)

(72) Inventors: Enliang SONG, Shanghai (CN); Tian HE, Shanghai (CN)

(21) Appl. No.: 18/057,768

(22) Filed: Nov. 22, 2022

Related U.S. Application Data
(63) Continuation of application No. PCT/CN2021/095605, filed on May 24, 2021.

(30) Foreign Application Priority Data
May 22, 2020 (CN) 202010443789.3

(51) Int. Cl. G06Q 10/0833

(52) U.S. Cl. CPC G06Q 10/0833

(57) ABSTRACT

The present disclosure provides information processing methods and devices. According to an embodiment of the method, when short distance information interaction is performed between a first electronic device used by a target delivery resource and a target device corresponding to a target shop, where a geographical location of the target device matches a geographical location of the target shop and the target delivery resource is for delivering a target object provided by the target shop to a target user, information for indicating the target delivery resource arrives at the target shop is obtained and then sent to a second electronic device used by the target user.

### CROSS REFERENCE TO RELATED APPLICATIONS

This application is a continuation of International Application No. PCT/CN2021/095605 filed on May 24, 2021, which claims priority to Chinese Patent Application No. 202010443789.3 filed on May 22, 2020. The contents of the referenced applications are hereby incorporated by reference in their entireties.

### TECHNICAL FIELD

The present disclosure relates to the field of information technological processing, and particularly to information processing methods, an electronic device, and a storage medium.

### BACKGROUND

At present, object delivery has become an important way for an entity object to provide an object to a user. For example, takeout, as a way for a merchant to provide dishes to a user by dish delivery, has gradually become normal in daily lives. When an object is delivered to a user by object delivery, it is usually required to provide an order state to the user to enable the user to know about a delivery progress and thus make reasonable time arrangement. When a delivery resource arrives at an entity object shop to take a to-be-delivered object and leaves the entity object shop to start delivery, it is required to synchronize an order state to the user. The real-time update of the order state directly affects user experiences and thus has significant importance. Therefore, how to obtain a time that a delivery resource arrives at an entity object shop and a time that the delivery resource leaves the entity object shop so as to update the order state based on actual order progress is a problem to be solved.

Furthermore, if the delivery resource can provide auxiliary additional services to the users in addition to basic object delivery, conveniences will be brought to the lives of people and user experiences will be improved. Thus, how to provide auxiliary additional services to users is a problem to be solved.

### SUMMARY

An embodiment of the present disclosure provides an information processing method by which a time that a delivery resource arrives at an entity object shop and a time that the delivery resource leaves the entity object shop can be obtained relatively accurately, so as to update an order state based on actual order delivery time as possible. The present disclosure further provides an information searching method and an instruction processing method to provide auxiliary additional services to a user.

An embodiment of the present disclosure provides an information processing method, including: detecting whether short distance information interaction is performed between a first electronic device used by a target delivery resource and a target device corresponding to a target shop, wherein a geographical location of the target device matches a geographical location of the target shop, and the target delivery resource is for delivering a target object; in response to detecting that the short distance information interaction is performed, obtaining information for indicating that the target delivery resource arrives at the target shop.

An embodiment of the present disclosure further provides an information processing method, which is applied to a service end or a target device corresponding to a target shop. A geographical location of the target device matches a geographical location of the target shop. The method includes: by short distance information interaction, obtaining first information of the target device corresponding to the target shop; sending the first information to an information recording device, where the first information is for indicating that a target delivery resource arrives at the target shop, and the target delivery resource is for delivering a target object.

An embodiment of the present disclosure further provides a method of obtaining time information, which is applied to a service end or a target device corresponding to a target shop. A geographical location of the target device matches a geographical location of the target shop. The method includes: obtaining first information of short distance interaction between a first electronic device used by a target delivery resource and the target device corresponding to the target shop, where the target delivery resource is used to deliver a target object; based on the first information, obtaining information of time when the target delivery resource arrives at the target shop.

An embodiment of the present disclosure further provides an information searching method, which is applied to a service end or a first electronic device used by a delivery resource. The delivery resource is for delivering an object. The method includes: obtaining a search request for information of a charge and discharge device, the search request being sent by a second electronic device used by a user; for the search request, obtaining the information of the charge and discharge device carried by the delivery resource, where the charge and discharge device is for charging and/or discharging an electronic device and the delivery resource is for delivering an object; sending the information of the charge and discharge device carried by the delivery resource to the second electronic device, or, displaying the information of the charge and discharge device carried by the delivery resource.

An embodiment of the present disclosure further provides an information searching method, which is applied to a service end or a first electronic device used by a delivery resource. The delivery resource is for delivering an object. The method includes: obtaining a search request for information of the delivery resource for recovering a charge and discharge device, the search request being sent by a second electronic device used by a user, where the charge and discharge device is for charging and/or discharging the electronic device, and the delivery resource is for delivering an object; for the search request, obtaining the information of the delivery resource for recovering the charge and discharge device; sending the information of the delivery resource for recovering the charge and discharge device to the second electronic device, or displaying the information of the delivery resource for recovering the charge and discharge device.

An embodiment of the present disclosure further provides an instruction processing method, which is applied to a first electronic device used by a delivery resource. The delivery resource is for delivering an object. The method includes: obtaining a delivery instruction for delivering a charge and discharge device carried by the delivery resource, which is sent by a second electronic device used by a user, where the charge and discharge device is for charging and/or discharging an electronic device; displaying the delivery instruction.

An embodiment of the present disclosure further provides an instruction processing method, which is applied to a first electronic device used by a delivery resource. The delivery resource is for delivering an object. The method includes: obtaining a recovery instruction for recovering a charge and discharge device delivered to a user, where the charge and discharge device is for charging and/or discharging an electronic device; displaying the recovery instruction.

An embodiment of the present disclosure further provides an instruction processing method, which is applied to a first electronic device used by a delivery resource. The delivery resource is for delivering an object. The method includes: obtaining a delivery instruction for instructing delivery of a charge and discharge device in a first charge and discharge device station to a second charge and discharge device station, where the charge and discharge device is for charging and/or discharging the electronic device, and the first charge and discharge device station and the second charge and discharge device station are for managing charge and discharge devices; displaying the delivery instruction.

An embodiment of the present disclosure further provides a method of processing charge and discharge device information, including: obtaining user information with a geographical location matching a geographical location of a target shop; sending charge and discharge device information corresponding to the target shop to a second electronic device corresponding to the user information, where the charge and discharge device information is information of a charge and discharge device for charging and/or discharging the electronic device, and a geographical location of the charge and discharge device matches the geographical location of the target shop.

An embodiment of the present disclosure further provides a method of processing charge and discharge device information, which is applied to a second electronic device corresponding to user information. The method includes: obtaining charge and discharge device information corresponding to a target shop, where the charge and discharge device information is information of a charge and discharge device for charging and/or discharging an electronic device, a geographical location of the charge and discharge device matches a geographical location of the target shop, and the geographical location of the target shop matches a geographical location of the second electronic device corresponding to the user information; displaying the charge and discharge device information corresponding to the target shop.

An embodiment of the present disclosure further provides an information processing method, including: obtaining information for indicating that a target user uses a charge and discharge device corresponding to a target shop, where a geographical location of the charge and discharge device matches a geographical location of the target shop, and the charge and discharge device is for charging and/or discharging an electronic device; sending service information that the target shop is capable of providing to the target user to a second electronic device corresponding to the target user.

An embodiment of the present disclosure further provides an information processing method, which is applied to a second electronic device used by a target user. The method includes: after sending a service request for using a charge and discharge device corresponding to a target shop, or, after settling an order for indicating use of the charge and discharge device corresponding to the target shop, or, after obtaining information for indicating that the target user returns the charge and discharge device corresponding to the target shop, obtaining service information that the target shop is capable of providing to the target user, wherein a geographical location of the charge and discharge device matches a geographical location of the target shop; displaying the service information that the target shop is capable of providing to the target user.

An embodiment of the present disclosure further provides a method of processing order information, including: obtaining service order information for indicating a target user obtains a service in a target shop; in response to obtaining device use order information for indicating that the target user uses a charge and discharge device in the target shop, obtaining settlement information corresponding to the target user in the target shop based on the service order information and the device use order information.

An embodiment of the present disclosure further provides a method of processing order information, including: sending a service request for indicating a target user requests a service in a target shop; sending a device use request for indicating the target user requests using a charge and discharge device in the target shop; obtaining summary order information of the target user in the target shop, where the summary order information includes information for indicating the target user obtains a service in the target shop and information for indicating the target user uses the charge and discharge device in the target shop; displaying the summary order information.

An embodiment of the present disclosure further provides a method of processing settlement information, including: obtaining settlement information corresponding to a target user in a target shop, where the settlement information includes first settlement information for a service obtained by the target user in the target shop, and second settlement information for use of a charge and discharge device in the target shop by the target user; displaying the settlement information corresponding to the target user in the target shop.

An embodiment of the present disclosure further provides an information providing method, including: in response to a settlement operation of a target merchant for a target user, sending discount information of a charge and discharge device corresponding to the target merchant to a second electronic device used by the target user.

An embodiment of the present disclosure further provides an electronic device, including a memory and a processor, where the memory is configured to store a computer program which is executed by the processor to perform the method of the embodiments of the present disclosure.

An embodiment of the present disclosure further provides a storage device, storing a computer program, which is executed by a processor to perform the method of the embodiments of the present disclosure.

### BRIEF DESCRIPTION OF THE DRAWINGS

FIG. 1 is a schematic diagram illustrating a first system environment according to an embodiment of the present disclosure.

FIG. 2 is a processing flowchart illustrating an information processing method according to a first embodiment of the present disclosure.

FIG. 3 is a schematic diagram illustrating an information interaction sequence according to a first embodiment of the present disclosure.

FIG. 4 is a processing flowchart illustrating an information processing method according to a second embodiment of the present disclosure.

FIG. 5 is a processing flowchart illustrating a method of obtaining time information according to a third embodiment of the present disclosure.

FIG. 6 is a scenario schematic diagram illustrating a second system environment according to an embodiment of the present disclosure.

FIG. 7 is a schematic diagram illustrating a second system environment according to an embodiment of the present disclosure.

FIG. 8 is a processing flowchart illustrating an information searching method according to a fourth embodiment of the present disclosure.

FIG. 9 is a processing flowchart illustrating an information searching method according to a fifth embodiment of the present disclosure.

FIG. 10 is a processing flowchart illustrating an instruction processing method according to a sixth embodiment of the present disclosure.

FIG. 11 is a processing flowchart illustrating an instruction processing method according to a seventh embodiment of the present disclosure.

FIG. 11A is a processing flowchart illustrating an instruction processing method according to an eighth embodiment of the present disclosure.

FIG. 12 is a schematic diagram illustrating a third system environment according to an embodiment of the present disclosure.

FIG. 13 is a processing flowchart illustrating a method of processing charge and discharge device information according to a ninth embodiment of the present disclosure.

FIG. 13A is a processing flowchart illustrating a method of processing charge and discharge device information according to a tenth embodiment of the present disclosure.

FIG. 14 is a processing flowchart illustrating an information processing method according to an eleventh embodiment of the present disclosure.

FIG. 14A is a processing flowchart illustrating an information processing method according to a twelfth embodiment of the present disclosure.

FIG. 15 is a processing flowchart illustrating a method of processing order information according to a thirteenth embodiment of the present disclosure.

FIG. 16 is a processing flowchart illustrating a method of processing order information according to a fourteenth embodiment of the present disclosure.

FIG. 17 is a processing flowchart illustrating a method of processing order information according to a fifteenth embodiment of the present disclosure.

FIG. 18 is a schematic diagram illustrating an electronic device according to an embodiment of the present disclosure.

FIG. 19 is a schematic diagram illustrating an information processing apparatus according to an eighteenth embodiment of the present disclosure.

FIG. 19A is a schematic diagram illustrating an information processing apparatus according to a nineteenth embodiment of the present disclosure.

FIG. 19B is a schematic diagram illustrating an apparatus for obtaining time information according to a twentieth embodiment of the present disclosure.

FIG. 20 is a schematic diagram illustrating an information searching apparatus according to a twenty-first embodiment of the present disclosure.

FIG. 20A is a schematic diagram illustrating an instruction processing apparatus according to a twenty-third embodiment of the present disclosure.

FIG. 21 is a schematic diagram illustrating an apparatus for processing charge and discharge device information according to a twenty-sixth embodiment of the present disclosure.

FIG. 21A is a schematic diagram illustrating an apparatus for processing charge and discharge device information according to a twenty-seventh embodiment of the present disclosure.

FIG. 21B is a schematic diagram illustrating an information processing apparatus according to a twenty-ninth embodiment of the present disclosure.

FIG. 22 is a schematic diagram illustrating an apparatus for processing order information according to a thirtieth embodiment of the present disclosure.

FIG. 22A is a schematic diagram illustrating an apparatus for processing order information according to a thirty-first embodiment of the present disclosure.

FIG. 22B is a schematic diagram illustrating an apparatus for processing settlement information according to a thirty-second embodiment of the present disclosure.

### DETAILED DESCRIPTION OF THE EMBODIMENTS

In the following descriptions, many details are set forth to help to fully understand the present disclosure. But, the present disclosure can be carried out in other manners different from those described herein and those skilled in the art can make similar expansion without departing from the meaning of the present disclosure. Thus, the present disclosure is not limited to the specific embodiments described below.

In the following embodiments, the methods, apparatuses, electronic devices and storage devices provided by the present disclosure are detailed one by one.

For ease of understanding, a first system environment provided by an embodiment of the present disclosure is firstly proposed. In practical applications, the ways that an entity object provides an object to a user become more and more flexible: an object is provided to a user by the user getting to a shop, that is, the user goes to the shop to obtain the object; an object may be provided to a user by delivery, that is, a delivery resource delivers an object provided by a shop to a user. The entity object refers to an entity providing an object to a user, for example, a shop merchant, or a merchant providing a takeout. The delivery resource, for example, a deliveryman, is used to deliver an object. The shop refers to a shop actually providing an object to a user, for example, an entity shop in the catering industry. The delivery way is an important way to provide an object. A delivery process is from acceptance of an order by a merchant to delivery of an object to a user. In a delivery process, an order state is provided to a user in time such that the user can know about a delivery progress and thus make reasonable arrangement. With takeout as an example, descriptions are made to a process in which an object is provided to a user by delivery. A user submits a takeout order to a service end through a smart phone, which is called ordering. The service end may be a service platform, or a computing device used by a merchant to accept orders. With a service platform as an example, the service platform provides the takeout order to a specific device corresponding to the merchant. The merchant returns an order acceptance to the service platform through the specific device, and then the service platform specifies a deliveryman for the takeout order. The deliveryman receives a delivery instruction by an electronic device (e.g. a smart phone) used by the deliveryman and then goes to the merchant shop to take food and then carries out food delivery. FIG. 1 shows a system environment where a method of an embodiment of the present disclosure is applied, including an electronic device 101 used by a delivery resource, a charge and discharge device cabin 102 and a server 103. The electronic device 101 used by the delivery resource may be a smart phone used by the deliveryman. After arriving at the entity object shop, the deliveryman uses the smart phone to perform short distance information interaction with the charge and discharge device cabin 102, for example, perform code scanning for a charge and discharge device. The charge and discharge device cabin (referred to as charge cabin hereinafter) is a storage cabin for storing a charge and discharge device, for example, a cabin for storing a power bank. The charge cabin is provided with at least one of digital labels such as a bar code, a two-dimensional code and an RFID label and the like. The smart phone of the deliveryman scans the bar code or two-dimensional code to obtain information of the charge cabin, or detects signals sent by the RFID label to obtain information of the charge cabin. The smart phone of the deliveryman reports the obtained information of the charge cabin to the server 103. The server is a device for receiving information reported by the smart phone of the deliveryman, which may be a server of the service platform, or another computing device or a computing device of another end. For example, the server may be a management device of the merchant shop or a server for managing the charge cabin, or a Consumer-end user device. The server is not limited to the device or end for receiving the information reported by the smart phone of the deliveryman. The smart phone of the deliveryman may also report information of the smart phone of the deliveryman and/or information of the deliveryman to the server, together with the information of the charge cabin. The smart phone of the deliveryman may also report location information of the smart phone of the deliveryman to the server. Hence, the server receiving the information reported by the smart phone of the deliveryman can identify information, such as that the deliveryman arrives at the shop and the time when the deliveryman arrives at the shop and the like. The server, based on the reported information, determines an order state and a delivery progress and feeds them back to a smart phone of a user, such that the user can make reasonable arrangement.

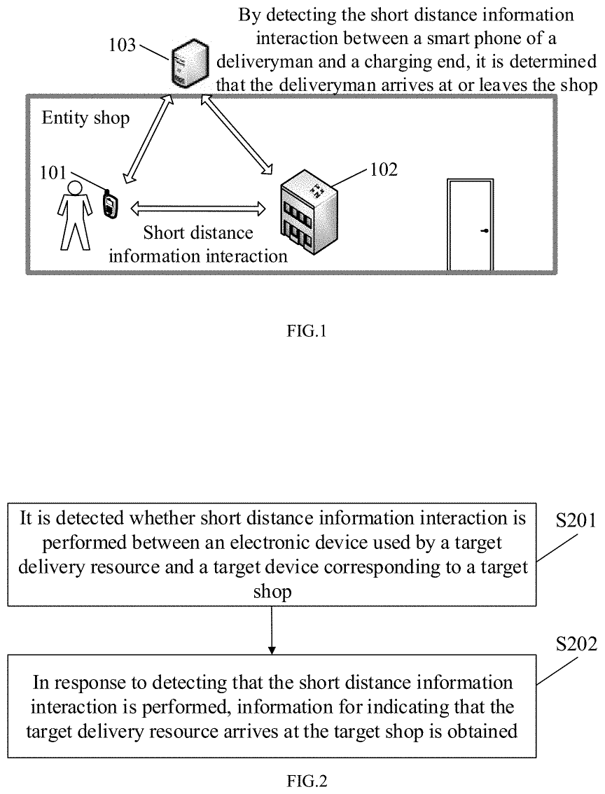

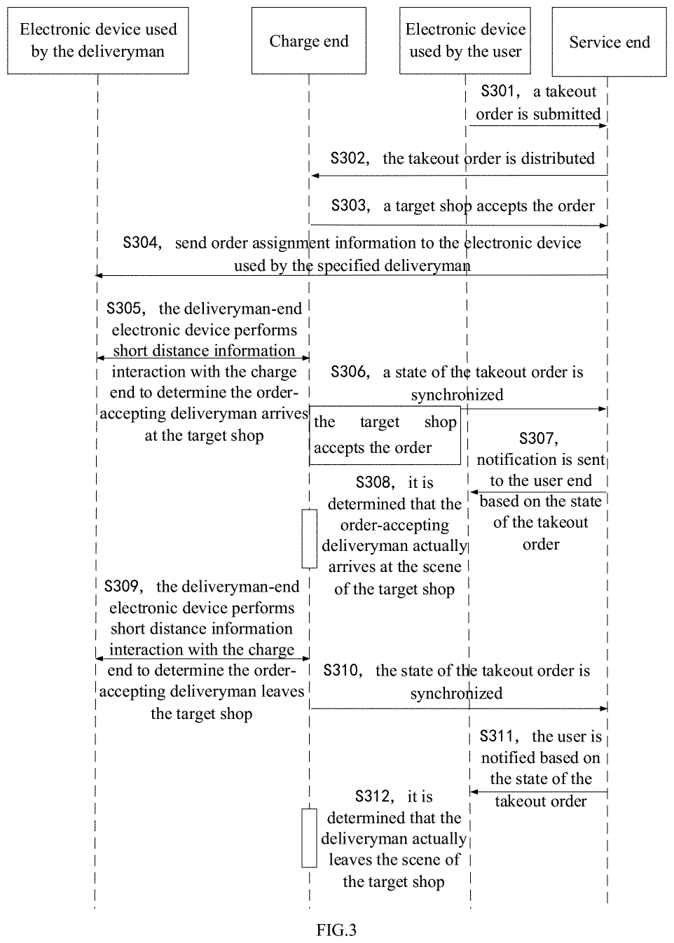

The first embodiment of the present disclosure provides an information processing method which is described in combination with FIGS. 2 and 3. The information processing method shown in FIG. 2 includes steps S201 to S202.

At step S201, it is detected whether short distance information interaction is performed between an electronic device used by a target delivery resource and a target device corresponding to a target shop. A geographical location of the target device matches a geographical location of the target shop. The target delivery resource is used to deliver a target object.

In the present embodiment, the electronic device used by the target delivery resource may be a smart phone of a deliveryman. The target shop is a shop providing an object to a user. The target device can perform short distance information interaction with the electronic device used by the target delivery resource to determine whether the electronic device arrives at a specific scope of the target device. If the electronic device arrives at the specific scope of the target device, it is indicated that the electronic device arrives at the target shop and is further indicated that the target delivery resource arrives at the target shop. The target device is used to store a charge and discharge device. The charge and discharge deice is used to charge and/or discharge an electronic device satisfying preset conditions. For example, the charge and discharge device is a device having the function of charging and/or discharging the electronic device. For another example, the charge and discharge device is a power bank. The target device may be a charge cabin with a geographical location matching a geographical location of the target shop. For example, the target device may be a charge cabin disposed inside the target shop, or disposed at a geographical location within a preset range of distance from the target shop. For another example, the target device may be a charge cabin bound to the target shop, which can be used to identify the scene of the target shop. In practical applications, it can be determined in many manners that the geographical location of the target device matches the geographical location of the target shop. For example, based on the binding relationship between the target device and the target shop, and/or a network identifier of the target device and a network identifier of a device in the target shop, it is determined that the geographical location of the target device matches the geographical location of the target shop. Specifically, the geographical location of the target device matching the geographical location of the target shop includes: there is a binding relationship between identification information of the target device and identification information of the target shop. Further, the geographical location of the target device matching the geographical location of the target shop also includes: a network identifier of a network accessed by the target device being same as a network identifier of a network accessed by at least one device in the target shop. For example, the network identifier may be specifically a Service Set Identifier (SSID) of a wireless local area network, and the devices with the same SSID are located in a same wireless local area network. For another example, the network identifier may be an identifier of a base station in a cellular communication network. The ID of the target device and the ID of the target shop are bound, and the target device and other devices of the target shop are in a same network, which indicates that the target device is located in the shop.

In practical applications, a user may submit a takeout order to a service platform through a smart phone application (APP), where a shop corresponding to the takeout order is a target shop. The service platform sends information of the takeout order to the target shop, and the target shop accepts the order and then notifies the service platform. The service platform specifies a target deliveryman for the takeout order, and sends a delivery instruction to a smart phone used by the target deliveryman. The delivery instruction includes information of the takeout order assigned to the target deliveryman for delivery. The target deliveryman arrives at the shop and uses the smart phone to perform code scanning for the charge cabin such that scanned information indicating arrival at the shop is submitted to the service platform. The service platform obtains the scanned information indicating arrival at the shop and determines the target deliveryman arrives at the shop. In this case, the service platform updates an order state of the takeout order and synchronizes it to a smart phone used by the user. When the target deliveryman takes food and leaves the shop, the target deliveryman performs code scanning for the charge cabin, such that scanned information indicating leaving the shop is submitted to the service platform. When the service platform obtains the scanned information indicating leaving the shop and determines the target deliveryman takes food and leaves the shop, the service platform updates the order state of the takeout order and synchronizes it to the smart phone used by the user. The smart phone used by the target deliveryman reports the information of the charge cabin obtained by code scanning to the service platform, with information of the smart phone and/or information about the deliveryman at the same time. The service platform, based on the information of the smart phone and/or information about the deliveryman, screens out a specific order assigned to the target deliveryman for delivery, and determines a specific shop to which the specific order belongs, and based on an identifier of the charge cabin bound to the specific shop, verifies whether the information of the charge cabin reported by this code scanning indicates the charge cabin of the specific shop, and thus determines the deliveryman performs code scanning for the charge cabin in the scene of the target shop. Hence, the user can know that the deliveryman really arrives at and leaves the scene of the target shop, and also know in time the times that the deliveryman takes food and starts to deliver the food. In the present embodiment, by determining whether short distance information interaction is performed between the electronic device used by the target delivery resource and the target device corresponding to the target shop, it is determined whether the target delivery resource arrives at the target shop. Specifically, according to the information obtained by the code scanning performed by the electronic device of the target delivery resource for the target device, it is determined whether short distance information interaction is performed between the electronic device used by the target delivery resource and the target device corresponding to the target shop. For example, by determining whether short distance information interaction is performed between the smart phone of the deliveryman and the charge cabin, it is determined whether the deliveryman arrives at the target shop.

In the present embodiment, specifically, by the following processing, it is detected whether short distance information interaction is performed between the electronic device used by the target delivery resource and the target device corresponding to the target shop: identification information for a first shop device, which is sent by a first electronic device, is obtained; based on the identification information for the first shop device, information of a first shop corresponding to the first shop device is obtained, and a geographical location of the first shop device matches a geographical location of the first shop; if information of the first electronic device indicates an electronic device corresponding to a target delivery resource in a first delivery order, and the information of the first shop indicates a target shop in the first delivery order, it is determined that short distance information interaction is performed between the electronic device used by the target delivery resource and the target device corresponding to the target shop. The first delivery order is used to indicate that the target delivery resource obtains the target object from the target shop and delivers the target object to the target user. Based on the identification information for the first shop device, obtaining the information of the first shop corresponding to the first shop device includes: based on the identification information for the first shop device and a correspondence between shop device information and shop information, obtaining the information of the first shop corresponding to the first shop device. Furthermore, the present embodiment further includes: obtaining a service request sent by the target user to request delivery of the target object to the target user; based on the service request, generating the first delivery order. The present embodiment further includes: sending the first delivery order to the electronic device used by the target delivery resource and sending the first delivery order to the target shop.

In an embodiment, by the following processing, it is detected whether short distance information interaction is performed between the electronic device used by the target delivery resource and the target device corresponding to the target shop: it is detected whether the electronic device sends short distance identification information for the target device; if yes, it is determined that short distance information interaction is performed between the electronic device and the target device. In practical applications, the smart phone of the deliveryman performs code scanning for the charge cabin and sends short distance identification information for identifying the charge cabin. The charge cabin may be provided with at least one of a bar code, a two-dimensional code and an RFID label. The deliveryman, by using the smart phone, scans the bar code or the two-dimensional code or detects signals sent by the RFID label based on near field communication protocol, so as to obtain the information of the charge cabin. The smart phone of the deliveryman sends the information of the charge cabin obtained by the code scanning to the server. The smart phone of the deliveryman may also send information of the smart phone and/or information about the deliveryman to the server, such that the server can further determine whether the deliveryman as the target delivery resource actually arrives at the target shop, so as to identify false order acceptance information, thereby avoiding update errors of the order state.

Furthermore, a geographical location of the target delivery resource is determined to more accurately determine that the target delivery resource identifies the target device in the scene of the target shop. In an embodiment, the electronic device used by the target delivery resource obtains the geographical location information and the identification information for the target device as short distance identification information. Namely, the short distance identification information for the target device includes: the identification information for the target device and the geographical location information of the target delivery resource. For example, the information sent by the smart phone of the deliveryman includes both identification information for the charge cabin and the location information of the deliveryman. Objectively, a location of the deliveryman matches a location of the charge cabin. Based on the identification information for the target device sent by the smart phone, it cannot be uniquely determined that such information is obtained by performing code scanning by using the smart phone on scene or by detecting signals of the RFID label. For example, the smart phone can also obtain information for a device by other non-on-scene method. Thus, by additionally identifying the location information of the deliveryman, it is guaranteed that the deliveryman obtains on scene the identification information for the charge cabin in the shop, avoiding provision of false location information. In an embodiment, determining whether the geographical location of the target delivery resource matches the geographical location of the target device may specifically include the following processing: it is detected whether the electronic device used by the target delivery resource sends the identification information for the target device, and it is determined whether the geographical location of the target delivery resource matches the geographical location of the target device; if it is detected that the electronic device used by the target delivery resource sends the identification information for the target device, and it is determined that the geographical location of the target delivery resource matches the geographical location of the target device, it is determined that the electronic device sends the short distance identification information for the target device. The geographical location of the target delivery resource may be obtained by the electronic device used by the target delivery resource or in another manner, for example, determining the geographic location of the target distribution resource based on a running trajectory of the target delivery resource.

In the present embodiment, the target device may also provide information to the server, so that it is determined whether short distance information interaction is performed between the electronic device used by the target delivery resource and the target device corresponding to the target shop, which, in an embodiment, specifically includes the following process: it is detected whether the target device sends a message that short distance information interaction is already performed between the electronic device and the target device. For example, based on NFC communication between the charge cabin and the smart phone of the deliveryman, the charge cabin obtains the information of the smart phone of the deliveryman and provides the information of the smart phone of the deliveryman and the information of the charge cabin to the server. In an embodiment, by the following processing, it is detected whether short distance information interaction is performed between the electronic device used by the target delivery resource and the target device corresponding to the target shop: it is detected whether the target device sends a message that short distance information interaction is already performed between the electronic device and the target device, and it is determined whether the geographical location of the target delivery resource and the geographical location of the target device are matched; if it is detected that the target device sends a message that short distance information interaction is already performed between the electronic device and the target device and it is determined that the geographical location of the target delivery resource and the geographical location of the target device are matched, it is determined that short distance information interaction is already performed between the electronic device and the target device. For example, the charge cabin provides to the server a message that short distance information interaction is already performed between the charge cabin and the smart phone of the deliveryman, so that it is determined the geographical location of the deliveryman and that the deliveryman is in the scene of the charge cabin. Thus, it is determined that short distance information interaction is already performed between the smart phone of the deliveryman and the charge cabin.

In the present embodiment, whether the electronic device performing on-scene interaction with the target device corresponds to the target delivery resource is further determined, that is, it is determined whether the smart phone performing on-scene interaction with the charge cabin corresponds to the deliveryman who should arrive at the shop to take food, which specifically includes the following processing: a first message that short distance information interaction is performed between the first electronic device and the target device is obtained, where the first message includes information of the first delivery resource corresponding to the first electronic device; it is determined whether the information of the first delivery resource indicates the target delivery resource which needs to take the target object from the target shop and delivers the target object to the target user; if yes, it is determined short distance information interaction is already performed between the electronic device and the target device. By the following processing, it is determined whether the information of the first delivery resource indicates the target delivery resource: it is determined whether the information of the first delivery resource indicates a target delivery resource in a to-be-completed order corresponding to the target shop, where the to-be-completed order corresponding to the target shop is an order for indicating that the target delivery resource needs to take the target object from the target shop and delivers the target object to the target user; if yes, it is determined that the information of the first delivery resource indicates the target delivery resource. Namely, by comparing the information of the deliveryman interacting with the charge cabin on scene with the information of the target deliveryman in the to-be-completed order corresponding to the target shop, the deliveryman is verified as the target deliveryman.

At step S202, if the determination result of step S201 is that the short distance information interaction is performed, information for indicating that the target delivery resource arrives at the target shop is obtained.

In the present embodiment, when it is detected whether short distance information interaction is performed between the electronic device used by the target delivery resource and the target device corresponding to the target shop as shown in step S201, if the detection result is that the short distance information interaction is performed, it is determined that the target delivery resource arrives at the target shop. Based on the information for indicating that the target delivery resource arrives at the target shop, an order state of the to-be-completed order is updated, for example, to that the deliveryman arrives at the shop to prepare for taking food, and the new order state is synchronized to the electronic device of the user, such as the smart phone of the user. In a scenario of practical applications, if it is confirmed that the deliveryman arrives at the shop and also it is detected that the deliveryman performs on-scene interaction with the charge cabin, it is confirmed that the deliveryman is about to leave the shop to deliver for the to-be-completed order. In this scenario, the following processing can be further performed: after the information for indicating that the target delivery resource arrives at the target shop is obtained, if it is detected once more that short distance information interaction is performed between the electronic device and the target device, the information for indicating that the target delivery resource leaves the target shop is obtained. Based on the information for indicating that the target delivery resource leaves the target shop, the order state of the to-be-completed order is updated, for example, to that the deliveryman already takes food and leaves the shop to start delivery, and the new order state is synchronized to the electronic device of the user, for example, the smart phone of the user. Thus, a finer notification of delivery process is provided to the user, helping the user to make reasonable arrangement and improving the user experiences. In practical applications, whether the deliveryman arrives at or leaves the shop can be confirmed in other ways. In an embodiment, the target device is provided with multiple digital labels, one of which is used to generate information of the short distance interaction between the electronic device used by the target delivery resource and the target device when the target delivery resource arrives at the target shop, and another is used to generate information of the short distance interaction between the electronic device used by the target delivery resource and the target device when the target delivery resource leaves the target shop. For example, the charge cabin may be provided with multiple two-dimensional codes, one of which is used for being scanned by the deliveryman at the time of arriving at the shop and another one is used for being scanned by the deliveryman at the time of leaving the shop. In this way, the short distance information interaction between the smart phone of the deliveryman and the charge cabin can be distinguished as information interaction for arrival at the shop or information interaction for leaving the shop. In an embodiment, the target device is provided with only one digital label, the electronic device used by the target delivery resource may determine arrival of the target delivery resource at the target shop or leaving the target shop, and send the determination result together with the information of short distance information interaction to the server.

As shown in FIG. 3, it shows a time sequence of information interaction among an electronic device used by the deliveryman (deliveryman-end electronic device), a charge end (a merchant end or bound to the merchant end), an electronic device used by the user (user-end electronic device), and a service end, which includes the following steps.

At step S301, a takeout order is submitted. The user submits the takeout order to an entity object (merchant) through the service end by using the user-end electronic device, for example, a smart phone. The service end may be a platform server or a merchant server.

At step S302, the takeout order is distributed. The service end distributes the takeout order to the merchant end or the charge end bound to the merchant end. In practical applications, the service end can distribute the takeout order to an order-accepting computing device used by the merchant end to accept orders, and the order-accepting computing device then sends the information of the takeout order to the charge end. The charge end is bound to the merchant end and/or, the geographical location of the charge end matches the geographical location of an order-accepting shop of the merchant end.

At step S303, a target shop accepts the order and feeds back order acceptance information to the service end.

At step S304, the service end sends order assignment information to the electronic device used by the specified deliveryman. The service end provides the order assignment information to the specified deliveryman and the specified deliveryman is an order-accepting deliveryman.

At step S305, the deliveryman-end electronic device performs short distance information interaction with the charge end to determine the order-accepting deliveryman arrives at the target shop. For example, the deliveryman performs code scanning using the smart phone, or enables the smart phone to perform NFC communication with the charge end, or uses the smart phone to identify the electronic label such as RFID label of the charge end.

At step S306, a state of the takeout order is synchronized. When the deliveryman arrives at the shop and prepares for taking food, the order state is updated and synchronized to the service end. Specifically, the service end may obtain information of short distance interaction between the electronic device used by the deliveryman and the charge end, and based on the information of the short distance interaction, determine the deliveryman arrives at the order-accepting shop and update the state of the takeout order.

At step S307, notification is sent to the user end based on the state of the takeout order. The service end sends notification information corresponding to the order state to the user based on the state of the takeout order.

At step S308, it is determined that the order-accepting deliveryman actually arrives at the scene of the target shop to ensure accurate and fine notification of delivery process can be fed back to the user.

At step S309, the deliveryman-end electronic device performs short distance information interaction with the charge end to determine the order-accepting deliveryman leaves the target shop.

At step S310, the state of the takeout order is synchronized. When the deliveryman takes food and leaves the shop to start delivery, the order state is updated and synchronized to the service end. Specifically, the service end may obtain the information of short distance interaction between the electronic device used by the deliveryman and the charge end, and based on the information of short distance interaction, determine the deliveryman leaves the order-accepting shop and update the state of the takeout order.

At step S311, the user is notified based on the state of the takeout order.

At step S312, it is determined that the deliveryman actually leaves the scene of the target shop, so as to ensure accurate notification of delivery process can be fed back to the user.

The method provided by the present embodiment can be applied to the target device, or to the service end providing services for the target delivery resource, the target shop and the target user. The application examples of the method are not limited to the charge end and the service end given by the embodiment. The method being applied to the target device may further include the following processing: the target device obtains a to-be-completed order provided by the service end or other devices of the target shop. For example, the method may be applied to the charge end and thus the charge end can obtain a to-be-completed order (e.g. to-be-completed takeout order) from the service end so as to determine whether the deliveryman interacting with the charge end on scene is an order-accepting deliveryman. The method being applied to the target device may further include the following: sending the information about that the delivery resource arrives at the target shop to the service end. For example, the charge end sends the information about that the deliveryman arrives at the shop to the service end. The method being applied to the service end providing services to the target delivery resource, the target shop and the target user may further include: obtaining a service request from the target user; based on the service request, generating the to-be-completed order. The present embodiment further includes: sending the information for indicating that the target delivery resource arrives at the target shop to the electronic device used by the target user, and/or, sending the information for indicating that the target delivery resource leaves the target shop to the electronic device used by the target user.

In an embodiment, the electronic device used by the target delivery resource may perform the following processing: first information of the target device corresponding to the target shop is obtained by short distance information interaction, where the geographical location of the target device matches the geographical location of the target shop. The first information is sent to the service end for recording the information for indicating that the target delivery resource arrives at the target shop, where the first information is for indicating that the target delivery resource arrives at the target shop. In practical application, the order-accepting deliveryman uses the smart phone to perform code scanning for the charge cabin of the charge end to obtain the information of the charge cabin, and provides the information of the charge cabin to the service end for the purpose of confirming arrival at the order-accepting shop or leaving the order-accepting shop. The order-accepting deliveryman is the target delivery resource and the smart phone used by the order-accepting deliveryman is the electronic device used by the target delivery resource. The charge cabin is the target device and the order-accepting shop is the target shop. The charge cabin is bound to the target shop or the geographical location of the charge cabin can be used to identify the scene of the target shop. The information of the charge cabin that the deliveryman obtains by performing code scan for the charge cabin by using the smart phone is the first information. The service end, based on the received first information, determines the order-accepting deliveryman arriving at the target shop and updates the order state of the to-be-completed order, and sends a notification to the electronic device corresponding to the target user based on the updated order state, for example, notifies the user of the information that “the deliveryman arrives at the shop and prepares to take food”. Furthermore, the method further includes: second information of the target device is obtained by short distance information interaction; the second information is sent to the service end, where the second information is used to indicate the target delivery resource leaves the target shop. The first information and the second information may be same or different. When the first information and the second information are different, specifically, code scanning is performed for arrival at the shop and leaving the shop respectively to obtain the first information for identifying arrival at the shop and the second information for identifying leaving the shop. The code scanning manners for arrival at the shop and leaving the shop are not limited and may specifically include: scanning the bar code, scanning the two-dimensional code, detecting the signals sent by the RFID label, performing near field (e.g. NFC) communication, performing Bluetooth interaction, and performing infrared interaction and the like. For example, the charge cabin is provided with different bar codes or two-dimensional codes, where the bar code or two-dimensional code to be scanned for arrival at the shop is different from the bar code or two-dimensional code to be scanned for leaving the shop. For another example, the charge cabin is provided with a dynamic digital label, which may be specifically a dynamically changing bar code or two-dimensional code. Code scanning is performed both for arrival at the shop and leaving the shop and different information is obtained for each scan. The first information and the second information may also be same. The service end may, based on a time sequence included in the first information and the second information, determine arrival at the shop or leaving the shop. Generally, for the information sent to the service end by the same smart phone of a deliveryman, the first information with earlier time is used to confirm arrival at the shop and the second information with later time is used to confirm leaving the shop. In one implementation, the time sequence may be determined based on times that the information arrives at the service end. In another implementation, time stamps included in the first information and the second information are obtained and the time sequence can be determined based on a sequence of the time stamps.

Thus, descriptions are made to the method of the first embodiment. In this method, by detecting short distance information interaction between the electronic device used by the target delivery resource and the target device corresponding to the target shop, the information for indicating that the target delivery resource arrives at the target shop is obtained to determine the delivery resource actually arrives at the target shop, and further, the times that the delivery resource arrives at the entity object shop and leaves the entity object shop are obtained. In this way, the problem of inability to update the order state based on the actual order delivery time is solved.

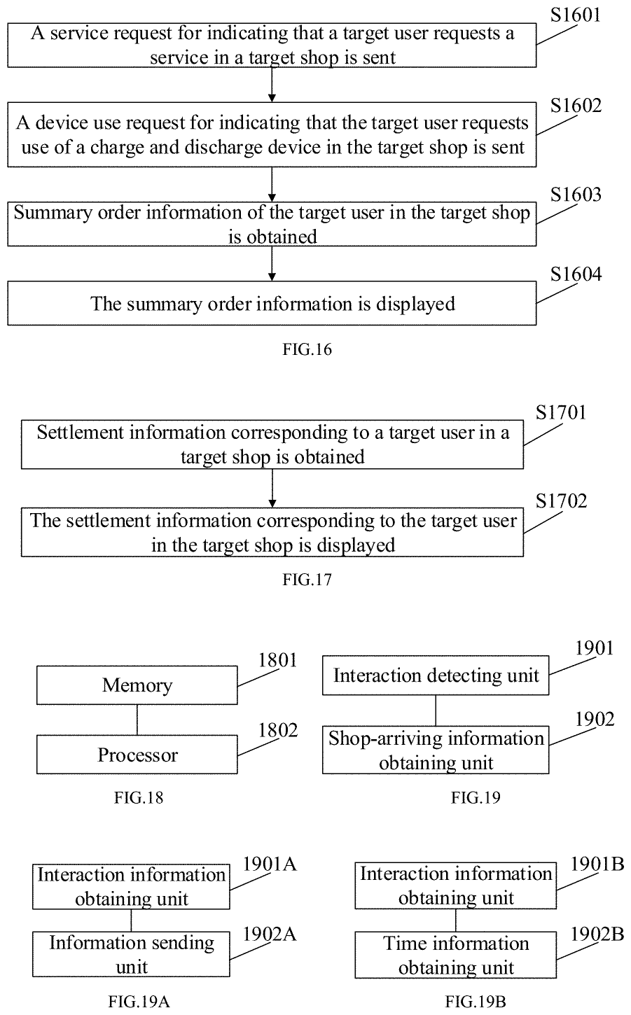

Correspondingly, the eighteenth embedment of the present disclosure provides an information processing apparatus, the structure of which, as shown in FIG. 19, includes an interaction detecting unit 1901 and a shop-arriving information obtaining unit 1902 to perform the steps of the above first embodiment. Relevant descriptions can be referred to the above first embodiment and will not be repeated herein.

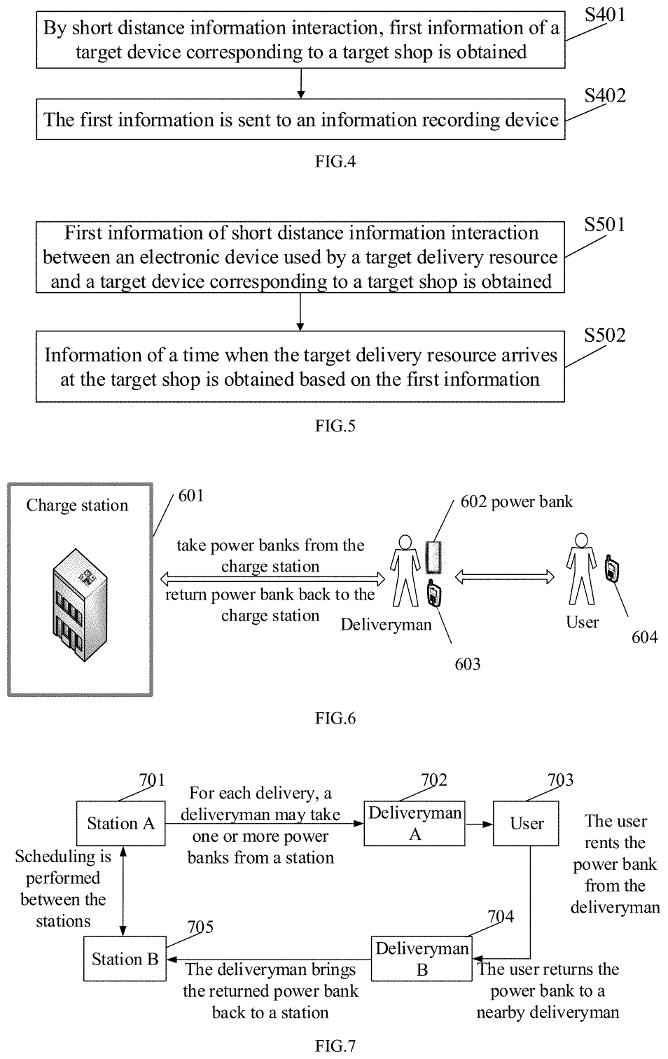

The second embodiment of the present disclosure provides another information processing method. The method provided by the second embodiment of the present disclosure will be described in combination with FIG. 4. The information processing method shown in FIG. 4 includes steps S401 to S402.

At step S401, by short distance information interaction, first information of a target device corresponding to a target shop is obtained, where a geographical location of the target device matches a geographical location of the target shop.

In the present embodiment, the short distance information interaction may be used to identify an identification code of the target device. The order-accepting deliveryman uses the smart phone to perform code scanning for the charge cabin of the charge end to obtain the information of the charge cabin, and provides the information of the charge cabin to the service end for the purpose of confirming arrival at the order-accepting shop or leaving the order-accepting shop. The order-accepting deliveryman is the target delivery resource and the smart phone used by the order-accepting deliveryman is the electronic device used by the target delivery resource. The charge cabin is the target device and the order-accepting shop is the target shop. The charge cabin is bound to the target shop or the geographical location of the charge cabin can be used to identify the scene of the target shop. The information of the charge cabin that the deliveryman obtains by performing code scanning for the charge cabin in a short distance with the smart phone is the first information. In practical applications, a user may submit a takeout order to a service platform through a smart phone APP, where a shop corresponding to the takeout order is a target shop. The service platform sends information of the takeout order to the target shop, and the target shop accepts the order and then notifies the service platform. The service platform specifies a target deliveryman for the takeout order, and sends a delivery instruction to a smart phone used by the target deliveryman. The delivery instruction includes information of the takeout order assigned to the target deliveryman for delivery. The target deliveryman arrives at the shop and uses the smart phone to perform code scanning for the charge cabin such that scanned information for arrival is submitted to the service platform. The service platform obtains the scanned information for arrival and determines the target deliveryman arrives at the shop. In this case, the service platform updates an order state of the takeout order and synchronizes it to a smart phone used by the user. When the target deliveryman takes food and leaves the shop, the target deliveryman performs code scanning for the charge cabin by using the smart phone, such that scanned information for leaving is submitted to the service platform. When the service platform obtains the scanned information for leaving and determines the target deliveryman takes food and leaves the shop, the service platform updates the order state of the takeout order and synchronizes it to the smart phone used by the user. The smart phone used by the target deliveryman reports information of the charge cabin obtained by code scanning to the service platform, with information of the smart phone and/or information about the deliveryman at the same time. The service platform, based on the information of the smart phone and/or information about the deliveryman, screens out a specific order assigned to the target deliveryman for delivery, and determines a specific shop to which the specific order belongs, and based on an identifier of the charge cabin bound to the specific shop, verifies whether the information of the charge cabin reported by this code scanning indicates the charge cabin of the specific shop, and thus determines whether the deliveryman performs code scanning for the charge cabin in the scene of the target shop. Hence, the user can know that the deliveryman really arrives at and leaves the scene of the target shop, and also know in time the times that the deliveryman takes food and starts to deliver the food. In the present embodiment, by determining whether short distance information interaction is performed between the electronic device used by the target delivery resource and the target device corresponding to the target shop, it is determined whether the target delivery resource arrives at the target shop. Specifically, according to the information obtained by the code scanning performed by the electronic device of the target delivery resource for the target device, it is determined whether short distance information interaction is performed between the electronic device used by the target delivery resource and the target device corresponding to the target shop. For example, by determining whether short distance information interaction is performed between the smart phone of the deliveryman and the charge cabin, it is determined whether the deliveryman arrives at the target shop.

At step S402, the first information is sent to an information recording device, where the first information is used to indicate the target delivery resource arrives at the target shop and the target delivery resource is for delivering a target object.

In this step, the service end, based on the received first information, determines the order-accepting deliveryman arrives at the order-accepting shop and updates the order state of the to-be-completed order, and based on the updated order state, sends a notification to the electronic device corresponding to the ordering user, for example, notifies the user of the information for indicating that the deliveryman already arrives at the shop and prepares to take food. The present embodiment further includes the following: second information of the target device is obtained by short distance information interaction; the second information is sent to the information recording device, where the second information is used to indicate the target delivery resource prepares to leave the target shop. The first information and the second information may be same or different. When the first information and the second information are different, specifically, code scanning is performed for arrival at the shop and leaving the shop respectively to obtain the first information for identifying arrival at the shop and the second information for identifying leaving the shop. The code scanning manners for arrival at the shop and leaving the shop are not limited and may specifically include: scanning the bar code, scanning the two-dimensional code, detecting the signals sent by the RFID label, performing near field (e.g. NFC) communication, performing Bluetooth interaction, and performing infrared interaction and the like. For example, the charge cabin is provided with different bar codes or two-dimensional codes, where the bar code or two-dimensional code to be scanned for arrival at the shop is different from the bar code or two-dimensional code to be scanned for leaving the shop. For another example, the charge cabin is provided with a dynamic digital label, which may be specifically a dynamically changing bar code or two-dimensional code. Code scanning is performed for arrival at the shop and leaving the shop and different information is obtained for each scan. The first information and the second information may also be same. The service end may, based on a time sequence included in the first information and the second information, determine arrival at the shop or leaving the shop. Generally, for the information sent to the service end by the same smart phone of a deliveryman, the first information with earlier time is used to confirm arrival at the shop and the second information with later time is used to confirm leaving the shop. In one implementation, the time sequence may be determined based on times that the information arrives at the service end. In another implementation, time stamps included in the first information and the second information are obtained and the time sequence can be determined based on a sequence of the time stamps.

Thus, descriptions are made to the method of the second embodiment. In this method, based on the information of short distance interaction with the target device, it is determined that the target delivery resource arrives at the target shop and thus it is determined the target delivery resource actually arrives at the target shop, so as to solve the problem of inability to accurately update the order state.

Correspondingly, a nineteenth embodiment of the present disclosure provides an information processing apparatus, which is applied to an electronic device used by a target delivery resource. The target delivery resource is used to deliver a target object. As shown in FIG. 19A, the apparatus includes an interaction information obtaining unit 1901A and an information sending unit 1902A to perform the steps of the above second embodiment. Relevant descriptions may be referred to the above second embodiment and will not be repeated herein.

On the basis of the above embodiment, one embodiment of the present disclosure provides another information processing method, including: obtaining information that short distance information interaction is already performed between a first electronic device and a first service device; obtaining first user information corresponding to information of the first electronic device; obtaining first shop information corresponding to information of the first service device, where a geographical location of the first service device matches a geographical location of a first shop corresponding to the first shop information; if the first user information indicates a target delivery resource in a to-be-completed target order and the first shop information indicates a target shop that the target delivery resource in the to-be-completed target order needs to arrive at, obtaining information for indicating that the target delivery resource arrives at the target shop, where the target delivery resource is for obtaining a target object from the target shop and delivering the target object to the target user. In the present embodiment, it is firstly determined that the smart phone performs short distance information interaction with the charge cabin of the charge end and then whether the user of the smart phone is an order-accepting deliveryman and the shop bound to the charge cabin or the shop matching the geographical location of the charge cabin are determined. If the user of the smart phone is one of deliverymen corresponding to to-be-completed order and the shop corresponding to the charge cabin is an order-accepting shop corresponding to the to-be-completed order and reached by the deliveryman, it is determined the order-accepting deliveryman corresponding to the to-be-completed order arrives at the order-accepting shop.

The third embodiment of the present disclosure provides a method of obtaining time information. The method will be described in combination with FIG. 5. The method of obtaining time information in FIG. 5 includes steps S501 to S502.

At step S501, first information of short distance information interaction between an electronic device used by a target delivery resource and a target device corresponding to a target shop is obtained. A geographical location of the target device matches a geographical location of the target shop, and the target delivery resource is for delivering a target object.

The steps included in the method of the present embodiment may be performed by a charge cabin of a charge end, or by a service end. The target device is a charge end. The charge end is bound to the target shop, and/or, a geographical location of the charge end matches the geographical location of the target shop. Thus, the location information of the charge end may be used to identify the scene of the target shop. Based on information of short distance interaction between the electronic device used by the target delivery resource and the target device corresponding to the target shop, it is determined that the electronic device is located at the scene of the target shop. In practical applications, a user may submit a takeout order to a service platform through a smart phone app, where a shop corresponding to the takeout order is the target shop. The service platform sends information of the takeout order to the target shop, and the target shop accepts the order and then notifies the service platform. The service platform specifies a target deliveryman for the takeout order, and sends a delivery instruction to a smart phone used by the target deliveryman. The delivery instruction includes information of the takeout order assigned to the target deliveryman for delivery. The target deliveryman arrives at the shop and uses the smart phone to perform code scanning for the charge cabin such that scanned information for arrival is submitted to the service platform. The service platform obtains the scanned information for arrival and determines the target deliveryman actually arrives at the shop. In this case, the service platform updates an order state of the takeout order and synchronizes it to a smart phone used by the user. When the target deliveryman takes food and leaves the shop, the target deliveryman performs code scanning for the charge cabin, such that scanned information for leaving is submitted to the service platform. When the service platform obtains the scanned information for leaving and determines the target deliveryman takes food and leaves the shop, the service platform updates the order state of the takeout order and synchronizes it to the smart phone used by the user. The smart phone used by the target deliveryman reports the information of the charge cabin obtained by code scanning to the service platform, with information of the smart phone and/or information about the deliveryman at the same time. The service platform, based on the information of the smart phone and/or information about the deliveryman, screens out a specific order assigned to the target deliveryman for delivery, and determines a specific shop to which the specific order belongs, and based on an identifier of the charge cabin bound to the specific shop, verifies whether the information of the charge cabin reported by this code scanning indicates the charge cabin of the specific shop, and thus determines the deliveryman performs code scanning for the charge cabin in the scene of the target shop. Hence, the user can know that the deliveryman really arrives at and leaves the scene of the target shop, and also know in time the times that the deliveryman takes food and starts to deliver the food. In the present embodiment, by determining whether short distance information interaction is performed between the electronic device used by the target delivery resource and the target device corresponding to the target shop, it is determined whether the target delivery resource arrives at the target shop. Specifically, according to the information obtained by the code scanning performed by the electronic device of the target delivery resource for the target device, it is determined whether short distance information interaction is performed between the electronic device used by the target delivery resource and the target device corresponding to the target shop. For example, by determining whether short distance information interaction is performed between the smart phone of the deliveryman and the charge cabin corresponding to the target shop, it is determined whether the deliveryman arrives at the target shop. Specifically, the first information includes first time information of short distance interaction between the electronic device and the target device. The first time information is used in subsequent steps to obtain a first time point and further to obtain the information of time when the target delivery resource arrives at the target shop.

At step S502, information of a time when the target delivery resource arrives at the target shop is obtained based on the first information.

In the present embodiment, the information of the time when the target delivery resource arrives at the target shop is obtained based on the first information. Specifically, if the first time information includes the first time point, the first time point is determined as the information of the time when the target delivery resource arrives at the target shop, or a time point with a preset time length earlier than the first time point is determined as the information of the time when the target delivery resource arrives at the target shop. If the first time information includes information of a first time segment, a time point in the first time segment is determined as the information of the time when the target delivery resource arrives at the target shop, or a time point with a first preset time length earlier than a start time point of the first time segment is determined as the information of the time when the target delivery resource arrives at the target shop. The present embodiment further includes: obtaining the information of the time when the target delivery resource leaves the target shop. Specifically, after the information of the time when the target delivery resource arrives at the target shop is obtained, if second information of short distance interaction between the electronic device and the target device is obtained, the information of the time when the target delivery resource leaves the target shop is obtained based on the second information. Furthermore, the second information includes the second time information of short distance interaction between the electronic device and the target device. If the second time information includes a second time point, the second time point is determined as the information of the time when the target delivery resource leaves the target shop, or a time point with a second preset time length later than the second time point is determined as the information of the time when the target delivery resource leaves the target shop. If the second time information includes information of a second time segment, a time point in the second time segment is determined as the information of the time when the target delivery resource leaves the target shop, or a time point with a second preset time length later than an end time point of the second time segment is determined as the information of the time when the target delivery resource leaves the target shop.

In the present embodiment, by the following processing, the first information of short distance interaction between the electronic device used by the target delivery resource and the target device corresponding to the target shop is obtained: identification information for a first shop device, which is sent by a first electronic device, is obtained; based on the identification information for the first shop device, information of a first shop corresponding to the first shop device is obtained, and a geographical location of the first shop device matches a geographical location of the first shop; if information of the first electronic device indicates an electronic device corresponding to a target delivery resource in a first delivery order, and the information of the first shop indicates a target shop in the first delivery order, the first information of short distance interaction between the electronic device used by the target delivery resource and the target device corresponding to the target shop can be obtained based on the identification information for the first shop device which is sent by the first electronic device. The first delivery order is used to indicate that the target delivery resource obtains the target object from the target shop and delivers the target object to the target user.

In a practical application, if the charge cabin performs the method, the charge cabin needs to send the information of the time when the target delivery resource arrives at the target shop and/or leaves the target shop to the service end. The service end feeds the information of the time back to the electronic device corresponding to the user. If the service end performs the method, the service end obtains the first information and/or second information of short distance interaction sent by the charge end or the smart phone of the deliveryman, and based on the first information and/or second information, determines the information of the time when the target delivery resource arrives at and/or leaves the target shop.

Thus, descriptions are made to the method of the third embodiment. In this method, by geographical location matching, the actual arrival of the delivery resource at the target shop and the time information of the arrival are determined, so as to obtain the time that the delivery resource arrives at the entity object shop, thereby solving the problem of inability to update the order state based on actual order progress.

Correspondingly, the twentieth embodiment of the present disclosure provides an apparatus for obtaining time information. As shown in FIG. 19B, the apparatus includes an interaction information obtaining unit 1901B and a time information obtaining unit 1902B to perform the steps of the above third embodiment. Relevant descriptions may be referred to the above third embodiment and will not be repeated herein.

On the basis of the above embodiment, the embodiment of the present disclosure further provides a second system environment. In the practical applications, a user places an order using a smart phone to an entity object shop through the service end, for example, submits a takeout order to the service end. The service end may be a service platform, or a computing device used by a merchant to accept orders. With a service platform as an example, the user submits, by using a smart phone, a takeout order for the target shop to the service platform, the service platform then distributes the takeout order to a merchant device, and the merchant device then returns order acceptance information to the service platform, and then the service platform specifies a deliveryman for the takeout order. Because there is a broad activity scope and a flexible route for delivery of the deliveryman, the deliveryman can, if the delivery capacity permits, provide auxiliary additional services to the user. For example, the deliveryman may carry a charge and discharge device (e.g. power bank) to provide the charge and discharge device to the user in time upon request of the user for rental during delivery. Preferably, based on convenience principle, on-the-way principle, or proximity principle, the charge and discharge device is provided to the user, or the charge and discharge device returned by the user is received, or a charged power bank is obtained from a charge station, or a used power bank returned from the user is returned to the charge station for charging, thereby saving delivery resources. The charge station may be a station for storing charge and discharge devices, and may include one or more charge cabins for storing charge and discharge devices. Besides normal delivery, the deliveryman also plays a role in providing a mobile charge station such that power banks can be more flexibly obtained from or returned to the mobile charge station, and thus a to-be-rented power bank can be provided to a user or a to-be-returned power bank can be obtained from the user.

FIG. 6 shows a scenario of a second system environment, including a charge station 601, a power bank 602 carried by a deliveryman, a smart phone 603 of the deliveryman, and a smart phone 604 of a user. The charge station 601 may be a station for storing charge and discharge devices, for example, include one or more charge cabins for storing charge and discharge devices. For each delivery, the deliveryman will take one or more power banks from the charge station 601 to transfer them to users having power bank renting requirements. The deliveryman may also, based on convenience principle, on-the-way principle or proximity principle, take a charged power bank, for example, a fully-charged power bank, from the charge station 601. The deliveryman may also, based on convenience principle, on-the-way principle or proximity principle, place a user-returned power bank back to the charge station 601 for unified charging management. The deliveryman may obtain a rental instruction for renting a power bank from a user through the smart phone 603. The user may search for a nearby rentable power bank by using the smart phone 604 and send a rental instruction to the smart phone 603.

FIG. 7 is a system block diagram illustrating a second system environment, including a station A 701, a deliveryman A 702, a user 703, a deliveryman B 704, and a station B 705. The stations are provided with cabin equipment to perform unified charge management. For each delivery, a deliveryman may take one or more power banks from a station. The user 703 searches for a nearby rentable power bank by using the smart phone and rents the power bank from the deliveryman. As shown herein, the user 703 rents a power bank from the deliveryman A 702. The user 703 returns the power bank to a nearby deliveryman. As shown herein, the user 703 returns the power bank to the deliveryman B 704. The deliveryman brings the returned power bank back to a station for unified charging management. Scheduling, transfer or allocation for the power banks may be performed between stations, for example, scheduling is performed between the station A 701 and the station B705. In practical applications, one or more charge stations may be deployed and the number of the charge stations is not limited to that shown herein. The deliveryman A and the deliveryman B may be a same deliveryman or different deliverymen, which is not limited specifically. Namely, the user may search for a nearby deliveryman to rent or return a power bank. The station A and the station B may be a same station or different stations, which is not specifically limited. Namely, a rented power bank may be returned to a station from which the power bank is taken or to a station different from the station from which the power bank is taken.

Based on the above system environment, the fourth embodiment of the present disclosure provides an information searching method. The information searching method in FIG. 8 may include steps S801 to S803.

At step S801, a search request for information of a charge and discharge device which is sent by a second electronic device is obtained.

In the present embodiment, a user may search for a nearby rentable power bank by using smart phone and send a rental instruction to a corresponding deliveryman. Specifically, the smart phone of the user sends the search request to a device performing the method. The device may be an electronic device used by a delivery resource or a service end.

At step S802, for the search request, information of a charge and discharge device carried by the delivery resource is obtained. The charge and discharge device is for charging and/or discharging the electronic device and the delivery resource is for delivering an object.

The delivery resource may be a plurality of delivery resources, and for the search request, information of a charge and discharge device carried by a delivery resource within a preset scope is obtained. The preset scope is set based on a geographical location of the user corresponding to the second electronic device.

At step S803, the information of the charge and discharge device carried by the delivery resource is sent to the second electronic device, or displayed.

In the present embodiment, the service end may send the information of the charge and discharge device carried by the delivery resource. The information is displayed by the electronic device used by the user, for example, a smart phone. The geographical location of the delivery resource matches the geographical location of the second electronic device, for example, the delivery resource is within the preset scope with the geographical location of the second electronic device as center. For the search request, obtaining the information of the charge and discharge device carried by the delivery resource includes: obtaining preliminarily-selected delivery resource information with the geographical location matching the geographical location of the second electronic device; selecting information of multi-selected delivery resources carrying currently-available charge and discharge device from the preliminarily-selected delivery resource information; obtaining information of the currently-available charge and discharge devices carried by the multi-selected delivery resources. The present embodiment further includes the following processing: after sending the information of the charge and discharge devices carried by the delivery resources to the second electronic device, obtaining a delivery request of a target charge and discharge device carried by a target delivery resource in the multi-selected delivery resources from the second electronic device; for the delivery request, sending a delivery instruction for delivering the target charge and discharge device to the first electronic device used by the target delivery resource. The present embodiment further includes the following processing: after displaying the information of the charge and discharge devices carried by the delivery resources, obtaining a first delivery request of the second electronic device for the target charge and discharge device carried by the target delivery resource in the multi-selected delivery resources; where the second device is used to send a second delivery request for the target charge and discharge device to the service end for providing services to the delivery resources. For example, the first delivery request is a request which is triggered by the user to request the deliveryman to deliver a power bank. The second delivery request is a rental request message sent by the smart phone of the user to the service end.

Thus, descriptions are made to the method provided by the embodiment. In the method, the information of the charge and discharge devices carried by the delivery resources is sent to the electronic device used by a user sending a search request for the charge and discharge devices, and thus the user can obtain the information and thus select a proper delivery resource and conveniently obtain a charge and discharge device, thereby solving the problem of how to provide auxiliary additional services to the users.

Correspondingly, the twenty-first embodiment of the present disclosure provides an information searching apparatus. As shown in FIG. 20, the apparatus includes a requesting unit 2001, an information obtaining unit 2002 and an information sending unit 2003, to perform the steps of the above fourth embodiment. Relevant descriptions can be referred to the above fourth embodiment and will not be repeated herein.

Based on the above system environment, the fifth embodiment of the present disclosure provides another information searching method. The information searching method in FIG. 9 includes steps S901 to S903.

At step S901, a search request for information of a delivery resource for recovering a charge and discharge device is obtained from a second electronic device. The charge and discharge device is used to charge and/or discharge the electronic device, and the delivery resource is for delivering an object.

In the present embodiment, a user may search, by using a smart phone, for nearby delivery resources capable of recovering a rented power bank, and specifies by using the smart phone, a specific delivery resource for recovering. Specifically, the smart phone of the user sends the search request to a device performing the method. The device is an electronic device used by a delivery resource or a service end.

At step S902, for the search request, information of a delivery resource for recovering the charge and discharge device is obtained.

The delivery resource may be a plurality of delivery resources, and for the search request, information of the delivery resources capable of recovering the charge and discharge device within a preset scope is obtained. The preset scope is set based on a geographical location of the user corresponding to the second electronic device.

At step S903, the information of the delivery resources for recovering the charge and discharge device is sent to the second electronic device, or displayed.

In the present embodiment, the geographical location of the delivery resource matches the geographical location of the second electronic device. Specifically, for the search request, obtaining the information of the delivery resource for recovering the charge and discharge device includes: obtaining preliminarily-selected delivery resource information with the geographical location matching the geographical location of the second electronic device (e.g. within a preset scope with the geographical location of the second electronic device as center); selecting information of multi-selected delivery resources currently capable of recovering the charge and discharge device from the preliminarily-selected delivery resource information. The present embodiment further includes: after sending the information of the delivery resources for recovering the charge and discharge device to the second electronic device, obtaining a recovery request for the target delivery resource in the multi-selected delivery resources to recover the target charge and discharge device from the second electronic device; for the recovery request, sending a recovery instruction for recovering the target charge and discharge device to the first electronic device used by the target delivery resource. The present embodiment further includes: after displaying the information of the multi-selected delivery resources, detecting, by the second electronic device, a selection operation of the user for the target delivery resource in the multi-selected delivery resources, and sending the recovery request for the target delivery resource to recover the target charge and discharge device to the service end providing services to the delivery resources.

Thus, descriptions are made to the method provided by the present embodiment. In the method, the information of the delivery resources for recovering the charge and discharge device is sent to the second electronic device sending the search request for information of the delivery resources for recovering the charge and discharge device, such that the user can select a proper delivery resource and conveniently return the charge and discharge device, so as to solve the problem of how to provide auxiliary additional services to the users.

Correspondingly, the twenty-second embodiment of the present disclosure provides an information searching apparatus. As shown in FIG. 20, the apparatus includes a requesting unit 2001, an information obtaining unit 2002, and an information sending unit 2003 to perform the steps of the above fifth embodiment. Relevant descriptions can be referred to the above fifth embodiment and will not be repeated herein.

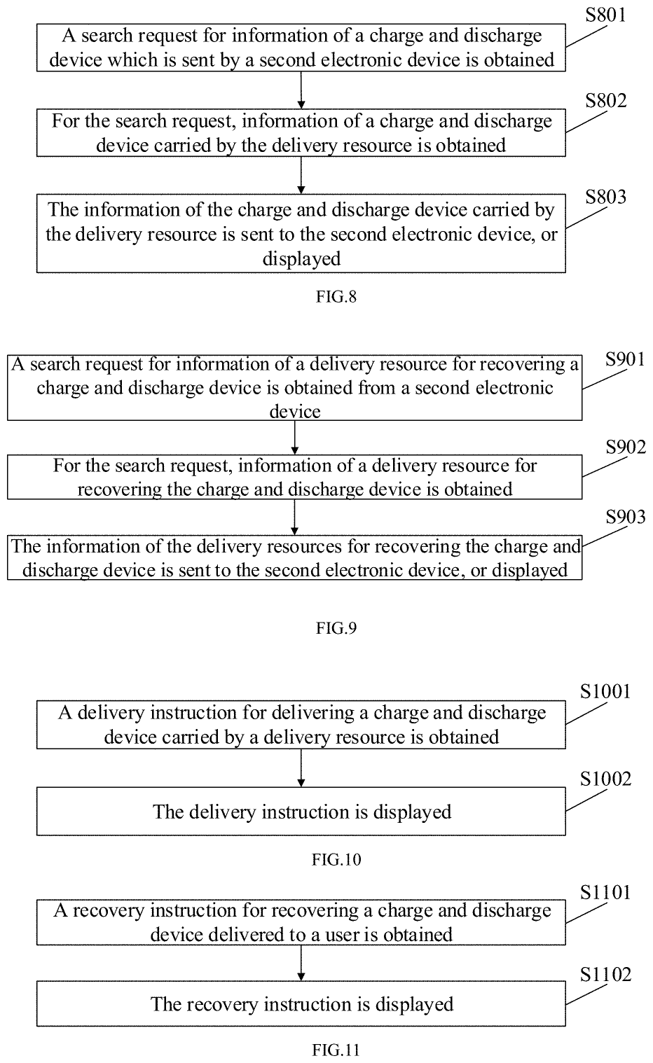

Based on the above system environment, the sixth embodiment of the present disclosure provides an instruction processing method. As shown in FIG. 10, the instruction processing method includes steps S1001 to S1002.

At step S1001, a delivery instruction for delivering a charge and discharge device carried by a delivery resource is obtained, where the charge and discharge device is for charging and/or discharging an electronic device, and the delivery resource is for delivering an object.

In the present embodiment, the delivery instruction includes information for instructing to deliver a target charge and discharge device in the charge and discharge devices carried by the delivery resource to a target position.

At step S1002, the delivery instruction is displayed.

In the present embodiment, the delivery instruction is displayed by the electronic device used by the delivery resource, such that the delivery resource can deliver the charge and discharge device based on the delivery instruction.

The present embodiment further includes: sending information of available charge and discharge devices carried by the delivery resource to a service end providing services to the delivery resource; where the target charge and discharge device is a charge and discharge device in the available charge and discharge devices. The present embodiment further includes:

sending state information of at least one charge and discharge device carried by the delivery resource to the service end providing services to the delivery resource; where the target charge and discharge device is a charge and discharge device with the state information satisfying preset state information. The present embodiment further includes: sending information of a charge and discharge device to be delivered or already delivered to the service end providing services to the delivery resource. The present embodiment further includes: obtaining a trigger operation of the delivery resource for the information of the charge and discharge device to be delivered or already delivered.

Thus, descriptions are made to the instruction processing method of the present embodiment. In the method, after the delivery instruction for delivering the charge and discharge device carried by the delivery resource is obtained, the delivery instruction is displayed such that the delivery resource can, based on the delivery instruction, deliver the carried charge and discharge device, thus solving the problem of how to provide auxiliary additional services to the users.

Correspondingly, the twenty-third embodiment of the present disclosure provides an instruction processing apparatus. As shown in FIG. 20A, the apparatus includes an instruction obtaining unit 2001A and an instruction displaying unit 2002A to perform the steps of the above sixth embodiment. Relevant descriptions can be referred to the above sixth embodiment and will not be repeated herein.

Based on the above system environment, the seventh embodiment of the present disclosure provides another instruction processing method. The instruction processing method shown in FIG. 11 can be applied to an electronic device used by a delivery resource. The delivery resource is used to deliver an object. The method includes steps S1101 to S1102.

At step S1101, a recovery instruction for recovering a charge and discharge device delivered to a user is obtained. The charge and discharge device is for charging and/or discharging an electronic device.

The recovery instruction includes information indicating a location from which the delivery resource obtains the charge and discharge device. The recovery instruction further includes information indicating a destination location to which the delivery resource delivers the charge and discharge device.

At step S1102, the recovery instruction is displayed.

The present embodiment further includes: sending information for indicating that the charge and discharge device is already obtained to the service end providing services to the delivery resource; obtaining information of a processing manner of the delivery resource for the charge and discharge device from the service end; displaying the information of the processing manner. The information about that the charge and discharge device is already obtained includes state information of the charge and discharge device.

Thus, descriptions are made to the instruction processing method of the present embodiment. In the method, after the electronic device used by the delivery resource obtains the recovery instruction for recovering the charge and discharge device delivered to the user, the recovery instruction is displayed, such that the delivery resource can recover the charge and discharge device based on the recovery instruction, thereby solving the problem of how to provide auxiliary additional services to the users.

Correspondingly, the twenty-fourth embodiment of the present disclosure provides an instruction processing apparatus. As shown in FIG. 20A, the apparatus includes an instruction obtaining unit 2001A and an instruction displaying unit 2002A to perform the steps of the above seventh embodiment. Relevant descriptions can be referred to the above seventh embodiment and will not be repeated herein.

Based on the above system environment, the eighth embodiment of the present disclosure provides another instruction processing method. As shown in FIG. 11A, the instruction processing method can be applied to an electronic device used by a delivery resource. The delivery resource may be used to deliver an object. The method includes steps S1101A to S1102A.

At step S1101A, a delivery instruction for instructing the delivery resource to deliver a charge and discharge device in a first charge and discharge device station to a second charge and discharge device station is obtained. The charge and discharge device is for charging and/or discharging an electronic device, and the first charge and discharge device station and the second charge and discharge device station are for managing the charge and discharge devices.

At step S1102A, the delivery instruction is displayed.

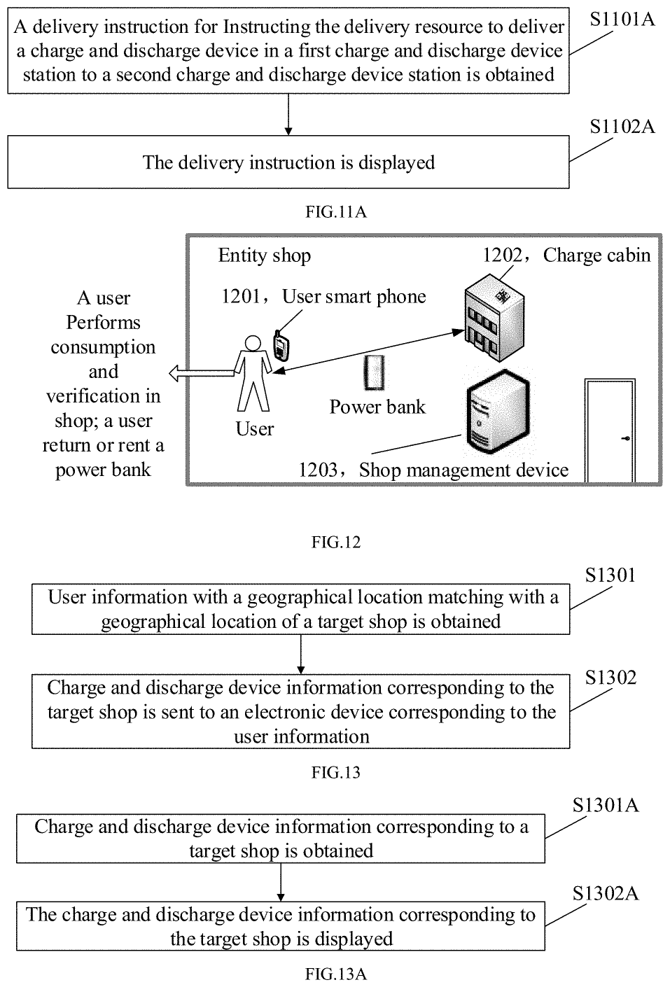

An embodiment of the present disclosure provides a third system environment. As shown in FIG. 12, the third system environment includes a user smart phone 1201, a charge cabin 1202, and a shop management device 1203. The consumption and/or verification behaviors of a user can be combined with the rental of the power bank, and coupons are also offered. During settlement of consumption and/or verification, the smart phone interacts with the shop management device. When renting a power bank, the user may perform code scanning for the charge cabin 1202 using the smart phone 1201, for example, scan an electronic label, or bar code or two-dimensional code or the like disposed on the charge cabin so as to complete the rental of the power bank. Of course, a power bank can be directly provided by a merchant to the user. Specifically, in a scenario, when a user arrives at a shop for consumption and/or verification, the shop issues a coupon for renting a power bank to the user. For example, the user purchases a commodity online (e.g. coupon-package commodity) and performs verification offline. In this case, if the merchant further provides a shared power bank service, it can issue a power bank coupon to the user after the user completes verification. In a scenario, when a user rents a power bank from a merchant, and completes settlement upon returning it, the merchant may issue a commodity coupon acceptable by the merchant to the user. The power bank can be returned in a place other than the shop, and the rent for the power bank may be settled with the merchant leasing the power bank. In a scenario of a user arriving at a shop, establishment of data channel between merchant data and power bank data is involved and information interaction between different platforms may also be involved. The in-shop services and shared power bank services provided by the merchant may correspond to different APP platforms and thus, information interaction between different platforms may also be involved. The specific data channel and information interaction do not limit the implementation of the method.

The twenty-fifth embodiment of the present disclosure provides an instruction processing apparatus, which can be applied to an electronic device used by a delivery resource. The delivery resource is used to deliver an object. As shown in FIG. 20A, the apparatus includes an instruction obtaining unit 2001A and an instruction displaying unit 2002A to perform the steps in the above eighth embodiment. Relevant descriptions can be referred to the above eighth embodiment of the present disclosure and will not be repeated herein.

Based on the above third system environment, the ninth embodiment of the present disclosure provides a method of processing charge and discharge device information. The method in FIG. 13 includes steps S1301 to S1302.

At step S1301, user information with a geographical location matching with a geographical location of a target shop is obtained.

The user information with the geographical location matching the geographical location of the target shop includes information of a user with the geographical location in the target shop.

The geographical location of the charge and discharge device matches the geographical location of the target shop, which includes the fact that the geographical location of the charge and discharge device is in the target shop.

At step S1302, charge and discharge device information corresponding to the target shop is sent to an electronic device corresponding to the user information. The charge and discharge device information is information of a charge and discharge device for charging and/or discharging an electronic device, and a geographical location of the charge and discharge device matches the geographical location of the target shop.

Sending the charge and discharge device information corresponding to the target shop to the electronic device corresponding to the user information includes: in response to obtaining consumption information corresponding to the user information and belonging to the target shop, sending the charge and discharge device information corresponding to the target shop to the electronic device corresponding to the user information. The method further includes: obtaining a service booking request sent by the electronic device corresponding to the user information. Correspondingly, in response to obtaining consumption information corresponding to the user information and belonging to the target shop, sending the charge and discharge device information corresponding to the target shop to the electronic device corresponding to the user information includes: in response to obtaining consumption information for the service booking request, which corresponds to the user information and belongs to the target shop, sending the charge and discharge device information corresponding to the target shop to the electronic device corresponding to the user information. The charge and discharge device information corresponding to the target shop includes use discount information of the charge and discharge device corresponding to the target shop.

Thus, descriptions are made to the method of the embodiment of the present disclosure. In the method, information of the charge and discharge device is provided to the user based on geographical location to help the user to select a proper charge and discharge device, thereby providing auxiliary additional services to the user.

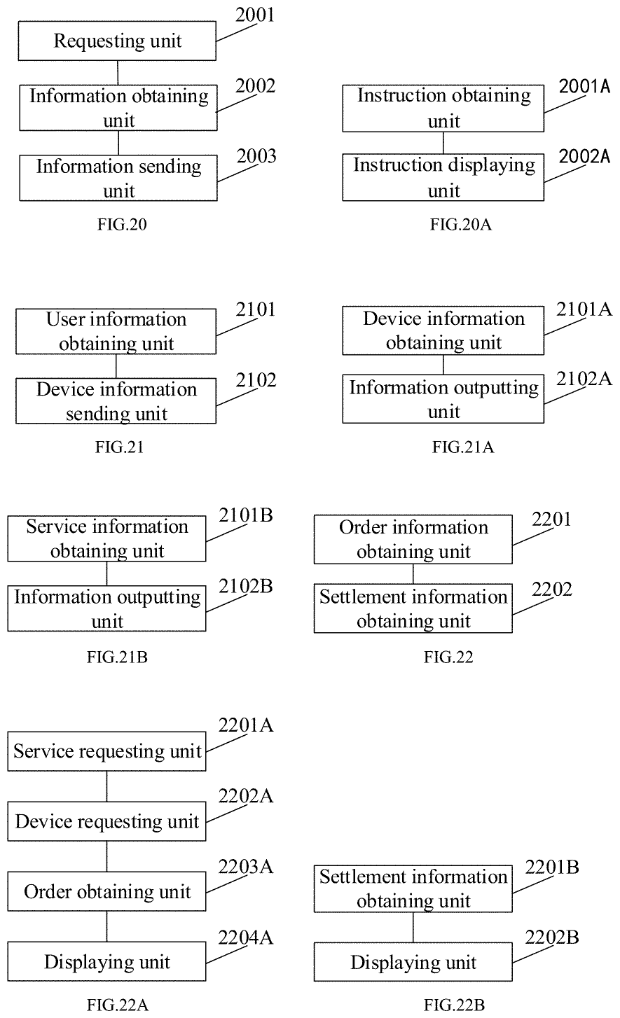

The twenty-sixth embodiment of the present disclosure provides an apparatus for processing charge and discharge device information. As shown in FIG. 21, the apparatus includes a user information obtaining unit 2101 and a device information sending unit 2102 to perform the steps of the above ninth embodiment. Relevant descriptions can be referred to the above ninth embodiment and will not be repeated herein.

Based on the above third system environment, the tenth embodiment of the present disclosure provides a method of processing charge and discharge device information. The method of processing charge and discharge device information shown in FIG. 13A can be applied to an electronic device corresponding to user information, and includes steps S1301A to S1302A.

At step S1301A, charge and discharge device information corresponding to a target shop is obtained. The charge and discharge device information is information of a charge and discharge device for charging and/or discharging an electronic device, a geographical location of the charge and discharge device matches a geographical location of the target shop, and the geographical location of the target shop matches a geographical location of the electronic device corresponding to the user information.

The charge and discharge device information corresponding to the target shop includes use discount information of the charge and discharge device corresponding to the target shop. The geographical location of the charge and discharge device matching the geographical location of the target shop includes the fact that the geographical location of the charge and discharge device is in the target shop. The geographical location of the target shop matching the geographical location of the electronic device corresponding to the user information includes the fact that the geographical location of the electronic device corresponding to the user information is in the target shop.

The present embodiment includes: before obtaining the charge and discharge device information corresponding to the target shop, sending a service booking request for the target shop, or sending settlement information for a service provided by the target shop.

At step S1302A, the charge and discharge device information corresponding to the target shop is displayed.

The twenty-seventh embodiment of the present disclosure provides an apparatus for processing charge and discharge device information, which can be applied to an electronic device corresponding to user information. As shown in FIG. 21A, the apparatus includes a device information obtaining unit 2101A and an information outputting unit 2102A to perform the steps of the above tenth embodiment. Relevant descriptions are made to the above tenth embodiment and will not be repeated herein.

Based on the above third system environment, the eleventh embodiment of the present disclosure provides an information processing method. The method shown in FIG. 14 includes steps S1401 to S1402.

At step S1401, information for indicating that a target user uses a charge and discharge device corresponding to a target shop is obtained. A geographical location of the charge and discharge device matches a geographical location of the target shop, and the charge and discharge device is for charging and/or discharging an electronic device.

The geographical location of the charge and discharge device matching the geographical location of the target shop includes the fact that the geographical location of the charge and discharge device is in the target shop. The information for indicating that the target user uses the charge and discharge device corresponding to the target shop includes information for indicating that the target user already returns the charge and discharge device. A geographical location of the target user is in the target shop.

At step S1402, service information that the target shop is capable of providing to the target user is sent to an electronic device corresponding to the target user.

The present embodiment further includes: performing settlement with the electronic device corresponding to the target shop on an order for indicating that the target user uses the charge and discharge device corresponding to the target shop.

The service information that the target shop can provide to the target user includes service discount information provided by the target shop to the target user.

Thus, descriptions are made to the method of the present embodiment. In the method, the information of the charge and discharge device is provided to the user based on geographical location to help the user to select a proper charge and discharge device, thereby solving the problem of how to provide auxiliary additional services to in-shop users of the target shop.

Correspondingly, the twenty-eighth embodiment of the present disclosure provides an information processing apparatus. As shown in FIG. 21A, the apparatus includes a device information obtaining unit 2101A and an information outputting unit 2102A to perform the steps of the above eleventh embodiment. Relevant descriptions can be referred to the above eleventh embodiment and will not be repeated herein.

Based on the above third system environment, the twelfth embodiment of the present disclosure provides another information processing method, which can be applied to an electronic device used by a target user. As shown in FIG. 14A, the method includes steps S1401A to S1402A.

At step S1401A, after a service request for using a charge and discharge device corresponding to the target shop is sent, or after an order for indicating use of the charge and discharge device corresponding to the target shop is settled, or, after information for indicating that the target user already returns the charge and discharge device corresponding to the target shop is obtained, service information that the target shop is capable of providing to the target user is obtained. A geographical location of the charge and discharge device matches a geographical location of the target shop.

The geographical location of the charge and discharge device matching the geographical location of the target shop includes the fact that the geographical location of the charge and discharge device is in the target shop. The geographical location of the target user is in the target shop.

At step S1402A, the service information that the target shop is capable of providing to the target user is displayed.

The service information that the target shop can provide to the target user includes service discount information that the target shop can provide to the target user.

The twenty-ninth embodiment of the present disclosure provides an information processing apparatus. As shown in FIG. 21B, the apparatus includes a service information obtaining unit 2101B and an information outputting unit 2102B to perform the steps of the above twelfth embodiment. Relevant descriptions can be referred to the above twelfth embodiment and will not be repeated herein.

An embodiment of the present disclosure further provides a fourth system environment with its schematic diagram similar to FIG. 12. The fourth system environment includes a user smart phone 1201, a charge cabin 1202, and a shop management device 1203. The settlement of consumption and/or verification of a user can be combined with rental order settlement of a power bank. During settlement of consumption and/or verification, the smart phone 1201 interacts with the shop management device 1203. When renting a power bank, the user may perform code scanning for the charge cabin 1202 using the smart phone, for example, scan an electronic label, or bar code or two-dimensional code or the like disposed on the charge cabin so as to complete the rental of the power bank. Of course, a merchant may directly provide a power bank to the user. In a specific scenario, a user orders foods by performing code scanning and also rents a shared power bank during the dining process. Therefore, the two orders can be combined for settlement so as to enjoy a rebate for the combined consumption. In a scenario of a user arriving at a shop, establishment of data channel between merchant data and power bank data is involved and information interaction between different platforms may also be involved. The in-shop services and shared power bank services provided by the merchant may correspond to different app platforms and thus, information interaction between different platforms may also be involved. The specific data channel and information interaction do not limit the implementation of the method.

Based on the above fourth system environment, the thirteenth embodiment of the present disclosure provides a method of processing order information. The method of processing order information shown in FIG. 15 includes steps S1501 to S1502.

At step S1501, service order information for indicating that a target user obtains a service in a target shop is obtained.

Device use order information for indicating that the target user uses a charge and discharge device in the target shop can be sent by an electronic device used by the target user or a target device for managing the charge and discharge device, which corresponds to the target shop.

The present embodiment further includes: obtaining first device use order information for indicating that a first user uses the charge and discharge device in the target shop; obtaining first user information included in the first device use order information; if the first user information indicates the target user, determining the device use order information for indicating that the target user uses the charge and discharge device in the target shop is obtained.

At step S1502, in response to the device use order information for indicating that the target user uses the charge and discharge device in the target shop is obtained, settlement information corresponding to the target user in the target shop is obtained based on the service order information and the device use order information.

Obtaining the settlement information corresponding to the target user in the target shop based on the service order information and the device use order information includes: combining the service order information and the device use order information into a summary order information of the target user in the target shop; performing settlement for the summary order information to obtain the settlement information corresponding to the target user in the target shop. The settlement information corresponding to the target user in the target shop is settlement information obtained after settlement is performed for the service order information and the device use order information based on the discount information.

Thus, descriptions are made to the method of the embodiment of the present disclosure. In the method, the service order information for indicating that the target user obtains a service in the target shop and the device use order information for indicating that the target user uses the charge and discharge device in the target shop are combined for processing to facilitate settlement by the user, thus solving the problem of how to provide auxiliary additional services to the in-shop users in the target shop.

The thirtieth embodiment of the present disclosure provides an information processing apparatus. As shown in FIG. 22, the apparatus includes an order information obtaining unit 2201 and a settlement information obtaining unit 2202 to perform the steps in the above thirteenth embodiment. Relevant descriptions can be referred to the above thirteenth embodiment and will not be repeated herein.

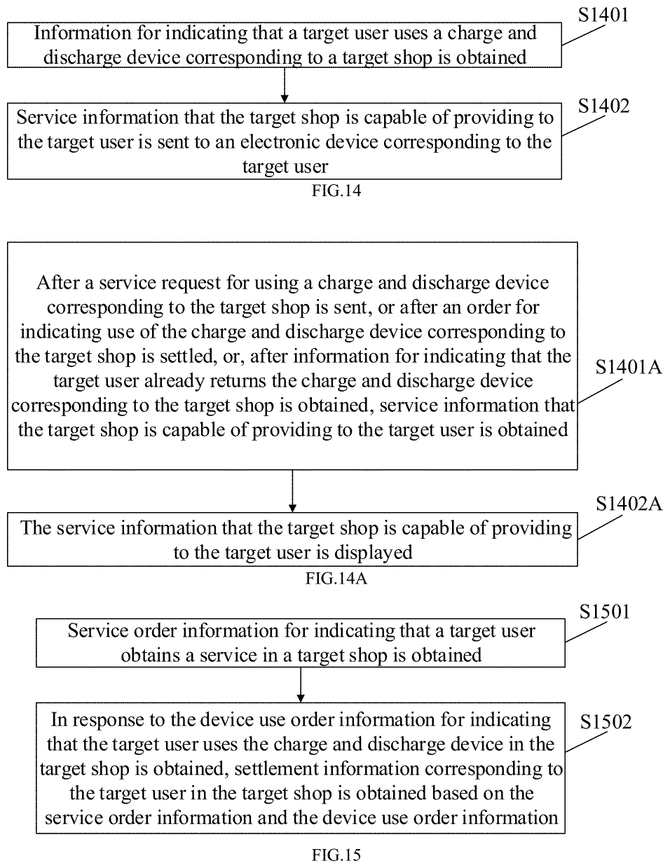

Based on the above fourth system environment, the fourteenth embodiment of the present disclosure provides another method of processing order information. The method of processing order information shown in FIG. 16 includes steps S1601 to S1604.

At step S1601, a service request for indicating that a target user requests a service in a target shop is sent.

At step S1602, a device use request for indicating that the target user requests use of a charge and discharge device in the target shop is sent.

At step S1603, summary order information of the target user in the target shop is obtained. The summary order information includes information for indicating that the target user obtains a service in the target shop and information for indicating that the target user uses the charge and discharge device in the target shop.

At step S1604, the summary order information is displayed.

The thirty-first embodiment of the present disclosure provides an apparatus for processing order information. As shown in FIG. 22A, the apparatus includes a service requesting unit 2201A, a device requesting unit 2202A, and an order obtaining unit 2203A to perform the steps in the above fourteenth embodiment. Relevant descriptions can be referred to the above fourteenth embodiment and will not be repeated herein.

Based on the above fourth system environment, the fifteenth embodiment of the present disclosure provides a method of processing settlement information. The method of processing settlement information shown in FIG. 17 includes steps S1701 to S1702.

At step S1701, settlement information corresponding to a target user in a target shop is obtained. The settlement information includes first settlement information for indicating for a service obtained by the target user in the target shop and second settlement information for indicating for use of a charge and discharge device in the target shop by the target user.

At step S1702, the settlement information corresponding to the target user in the target shop is displayed.

The thirty-second embodiment of the present disclosure provides an apparatus for processing settlement information. As shown in FIG. 22B, the apparatus includes a settlement information obtaining unit 2201B and a displaying unit 2202B, to perform the steps in the above fifteenth embodiment. Relevant descriptions can be referred to the above fifteenth embodiment and will not be repeated herein.

Based on the above embodiment, the sixteenth embodiment of the present disclosure provides an electronic device. FIG. 18 is a schematic diagram illustrating the electronic device. The electronic device includes a memory 1801 and a processor 1802. The memory is configured to store a computer program which is executed by the processor to perform the method of the embodiments of the present disclosure.

The seventeenth embodiment of the present disclosure provides an electronic device with relevant parts referred to the corresponding descriptions of the above embodiment. The schematic diagram of the electronic device is similar to FIG. 18 and includes a memory 1801 and a processor 1802. The memory stores a computer program which is executed by the processor 1802 to perform the method of the embodiments of the present disclosure. The thirty-third embodiment of the present disclosure provides an information providing method, which includes the following steps: in response to a settlement operation of a target merchant for a target user, sending discount information of a charge and discharge device corresponding to the target merchant to an electronic device used by the target user. The settlement operation of the target merchant for the target user may include performing verification processing for target service voucher information, where the target service voucher information is voucher information that the target user books a service in the target merchant.

In the present embodiment, a service booking request for booking a service of the target merchant may be firstly obtained from the electronic device used by the target user. For example, the target user may, through the electronic device, send a service booking request for booking a service of the target merchant. The service herein may refer to not only commodities of the target merchant but also other services than the commodities of the target merchant. Afterwards, voucher information that the target user books the service in the target merchant is generated. Then, target service voucher information that the target user books the service in the target merchant is sent to the electronic device used by the target user. The target service voucher information may be displayed by voucher identification information such as two-dimensional code in the electronic device used by the target user and may specifically include element information required to generate the voucher identification information in the electronic device of the target user.

In the present embodiment, after the target user arrives at the target merchant, the target merchant may perform verification for the target service voucher information. During specific implementation, the target user may, by using the electronic device, display the above voucher identification information and the electronic device of the target merchant identifies the voucher identification information to obtain the information of the service to be provided to the target user and performs verification operation for the voucher identification information.

In the present embodiment, the settlement operation of the target merchant for the target user may also include: a settlement operation of the target merchant for the services provided to the target user in the target merchant, for example, a settlement operation for the on-scene services provided in the target merchant after the target user obtains the services from the target merchant in the scene of target merchant.

In the present embodiment, the target merchant may provide services related to the charge and discharge device to the user, for example, provide rental services related to the charge and discharge device. In response to the settlement operation for the target user, the target merchant may issue discount information of the charge and discharge device to the electronic device used by the target user. The discount information, for example, may be a coupon usable by the target user for renting the charge and discharge of the target merchant.

After the electronic device used by the target user obtains the above discount information, the target user may determine, at his own discretion, whether to use the charge and discharge device of the target merchant by using the discounting information. If it is determined to use the charge and discharge device of the target merchant, rental of the charge and discharge device can be settled using the discount information.

Corresponding to the above thirty-third embodiment, the third-fourth embodiment of the present disclosure provides an information providing apparatus, including an information providing unit configured to, in response to a settlement operation of a target merchant for a target user, send discount information of a charge and discharge device corresponding to the target merchant to an electronic device used by the target user.

Relevant descriptions of the present embodiment can be referred to relevant descriptions of the above thirty-second embodiment and will not be repeated herein.

Among the above-described embodiments, any one embodiment can be combined with another one or a plurality of embodiments to form a new embodiment, and the detailed combination manner is not limited in the disclosure.

In the disclosure, an embodiment provides an information processing method, including: detecting whether short distance information interaction is performed between a first electronic device used by a target delivery resource and a target device corresponding to a target shop, where a geographical location of the target device matches a geographical location of the target shop, and the target delivery resource is for delivering a target object; in response to detecting that the short distance information interaction is performed, obtaining first information for indicating that the target delivery resource arrives at the target shop.

In some examples, where detecting whether short distance information interaction is performed between a first electronic device used by a target delivery resource and a target device corresponding to a target shop includes: obtaining identification information for a first shop device transmitted by the first electronic device; obtaining information of a first shop based on the identification information for the first shop device; and in response to that the information of the first shop indicates the target shop, determining that the short distance information interaction is performed between the first electronic device and the target device.

In some examples, the above method further includes: in response to detecting that the short distance information interaction is performed again after the first information is obtained, obtaining second information for indicating that the target delivery resource leaves the target shop.

In some examples, the above method further includes: updating a state of a delivery order based on at least one of the first information and the second information, and synchronizing the updated state to a user submitting the delivery order, where the deliver order instructs the target delivery resource to deliver the target object to the user.

In some examples, where updating a state of a delivery order based on at least one of the first information and the second information includes: based on the first information, obtaining arrival time when the target delivery resource arrives at the target shop; based on the second information, obtaining leaving time when the target delivery resource leaves the target shop; and updating the state of the delivery order based on at least one of the arrival time and the leaving time.

In some examples, the above method further includes: obtaining a search request for information of a charge and discharge device, the search request being sent by a second electronic device used by a user; for the search request, obtaining information of one or more charge and discharge devices carried by one or more delivery resources, where the charge and discharge device is for charging and/or discharging an electronic device; sending the information of the charge and discharge devices carried by the delivery resources to the second electronic device, or, displaying the information of the charge and discharge devices carried by the delivery resources.

In some examples, the above method further includes: obtaining a search request for information of a delivery resource for recovering a charge and discharge device, the search request being sent by a second electronic device used by a user, where the charge and discharge device is for charging and/or discharging an electronic device, and the delivery resource is for delivering an object; for the search request, obtaining information of one or more delivery resources for recovering the charge and discharge device; sending the information of the delivery resources for recovering the charge and discharge device to the second electronic device, or displaying the information of the delivery resources for recovering the charge and discharge device.

In some examples, the above method further includes: obtaining a delivery instruction for delivering a charge and discharge device carried by the target delivery resource, where the charge and discharge device is for charging and/or discharging an electronic device; displaying the delivery instruction.

In some examples, the above method further includes: obtaining a recovery instruction for recovering a charge and discharge device delivered to a user, where the charge and discharge device is for charging and/or discharging an electronic device; displaying the recovery instruction.

In some examples, the above method further includes: obtaining user information with a geographical location matching a geographical location of the target shop; sending charge and discharge device information corresponding to the target shop to a second electronic device corresponding to the user information, where the charge and discharge device information is information of a charge and discharge device for charging and/or discharging an electronic device, and a geographical location of the charge and discharge device matches the geographical location of the target shop.

In the disclosure, an embodiment provides an information processing method, including: obtaining device use order information for indicating that a target user uses a charge and discharge device corresponding to a target shop, where a geographical location of the charge and discharge device matches a geographical location of the target shop, and the charge and discharge device is for charging and/or discharging an electronic device; sending service information that the target shop is capable of providing to the target user to a second electronic device corresponding to the target user.

In some examples, the above method further includes: in response to obtaining service order information for indicating that the target user obtains a service in the target shop; obtaining settlement information corresponding to the target user in the target shop based on the service order information and the device use order information.

In some examples, the above method further includes: in response to a settlement operation for the target user, sending discount information of a charge and discharge device corresponding to the target shop to a second electronic device used by the target user.

In the disclosure, an embodiment provides an information processing method, including: after sending a service request for using a charge and discharge device corresponding to a target shop, or, after settling an order for indicating use of the charge and discharge device corresponding to the target shop, or, after obtaining information for indicating that the target user returns the charge and discharge device corresponding to the target shop, obtaining service information that the target shop is capable of providing to the target user, where a geographical location of the charge and discharge device matches a geographical location of the target shop; displaying the service information that the target shop is capable of providing to the target user.

In some examples, the above method further includes: obtaining summary order information of the target user in the target shop, where the summary order information comprises at least one of information for indicating that the target user obtains a service in the target shop and information for indicating that the target user uses the charge and discharge device in the target shop; displaying the summary order information.

In the disclosure, an embodiment provides an electronic device, including: a processor and a non-transitory storage medium storing machine readable instructions, where the machine readable instructions are executed by the processor to implement the above method.

In the disclosure, an embodiment provides a non-transitory storage medium, including: a computer program, where the computer program is executed by a processor to implement the above method.

The present disclosure is described with preferred embodiments as above, but these preferred embodiments are not used to limit the present disclosure. Those skilled in the art may make possible changes and modifications within the spirit and scope of the present disclosure. Thus, the scope of protection of the present disclosure shall be indicated by the appended claims.

We claim:

1. An information processing method, comprising:
detecting whether short distance information interaction is performed between a first electronic device used by a target delivery resource and a target device corresponding to a target shop, wherein a geographical location of the target device matches a geographical location of the target shop, and the target delivery resource is for delivering a target object; and
in response to detecting that the short distance information interaction is performed, obtaining first information for indicating that the target delivery resource arrives at the target shop.

2. The information processing method according to claim 1, wherein detecting whether short distance information interaction is performed between a first electronic device used by a target delivery resource and a target device corresponding to a target shop, comprises:
obtaining identification information for a first shop device transmitted by the first electronic device;
obtaining information of a first shop based on the identification information for the first shop device; and
in response to that the information of the first shop indicates the target shop, determining that the short distance information interaction is performed between the first electronic device and the target device.

3. The information processing method according to claim 1, further comprising:
in response to detecting that the short distance information interaction is performed again after the first information is obtained, obtaining second information for indicating that the target delivery resource leaves the target shop.

4. The information processing method according to claim 3, further comprising:
updating a state of a delivery order based on at least one of the first information and the second information, and synchronizing the updated state to a user submitting the delivery order,
wherein the deliver order instructs the target delivery resource to deliver the target object to the user.

5. The information processing method according to claim 4, wherein updating a state of a delivery order based on at least one of the first information and the second information, comprises:
based on the first information, obtaining arrival time when the target delivery resource arrives at the target shop;
based on the second information, obtaining leaving time when the target delivery resource leaves the target shop; and
updating the state of the delivery order based on at least one of the arrival time and the leaving time.

6. The information processing method according to claim 1, further comprising:
obtaining a search request for information of a charge and discharge device, the search request being sent by a second electronic device used by a user;
for the search request, obtaining information of one or more charge and discharge devices carried by one or more delivery resources, wherein the charge and discharge device is for charging and/or discharging an electronic device;
sending the information of the charge and discharge devices carried by the delivery resources to the second electronic device or displaying the information of the charge and discharge devices carried by the delivery resources.

7. The information processing method according to claim 1, further comprising:
obtaining a search request for information of a delivery resource for recovering a charge and discharge device, the search request being sent by a second electronic device used by a user, wherein the charge and discharge device is for charging and/or discharging an electronic device, and the delivery resource is for delivering an object;
for the search request, obtaining information of one or more delivery resources for recovering the charge and discharge device;
sending the information of the delivery resources for recovering the charge and discharge device to the second electronic device, or displaying the information of the delivery resources for recovering the charge and discharge device.

8. The information processing method according to claim 1, further comprising:
obtaining a delivery instruction for delivering a charge and discharge device carried by the target delivery resource, wherein the charge and discharge device is for charging and/or discharging an electronic device;
displaying the delivery instruction.

9. The information processing method according to claim 1, further comprising:
obtaining a recovery instruction for recovering a charge and discharge device delivered to a user, wherein the charge and discharge device is for charging and/or discharging an electronic device;
displaying the recovery instruction.

10. The information processing method according to claim 1, further comprising:
obtaining user information with a geographical location matching a geographical location of the target shop;
sending charge and discharge device information corresponding to the target shop to a second electronic device corresponding to the user information, wherein the charge and discharge device information is information of a charge and discharge device for charging and/or discharging an electronic device, and a geographical location of the charge and discharge device matches the geographical location of the target shop.

11. An information processing method, comprising:
obtaining device use order information for indicating that a target user uses a charge and discharge device corresponding to a target shop, wherein a geographical location of the charge and discharge device matches a geographical location of the target shop, and the charge and discharge device is for charging and/or discharging an electronic device;
sending service information that the target shop is capable of providing to the target user to a second electronic device corresponding to the target user.

12. The information processing method according to claim 11, further comprising:
in response to obtaining service order information for indicating that the target user obtains a service in the target shop;
obtaining settlement information corresponding to the target user in the target shop based on the service order information and the device use order information.

13. The information processing method according to claim 12, further comprising:
in response to a settlement operation for the target user, sending discount information of a charge and discharge device corresponding to the target shop to a second electronic device used by the target user.

14. An information processing method, comprising:
after sending a service request for using a charge and discharge device corresponding to a target shop, or, after settling an order for indicating use of the charge and discharge device corresponding to the target shop, or, after obtaining information for indicating that the target user returns the charge and discharge device corresponding to the target shop, obtaining service information that the target shop is capable of providing to the target user, wherein a geographical location of the charge and discharge device matches a geographical location of the target shop;
displaying the service information that the target shop is capable of providing to the target user.

15. The information processing method according to claim 14, further comprising:
obtaining summary order information of the target user in the target shop, wherein the summary order information comprises at least one of information for indicating that the target user obtains a service in the target shop and information for indicating that the target user uses the charge and discharge device in the target shop;
displaying the summary order information.

16. An electronic device, comprising: a processor and a non-transitory storage medium storing machine readable instructions, wherein the machine readable instructions are executed by the processor to implement the method according to claim 1.

17. A non-transitory storage medium comprising a computer program, wherein the computer program is executed by a processor to implement the method according to claim 1.
